(19) United States
(12) Patent Application Publication
(10) Pub. No.: US 2026/0368025 A1
(43) Pub. Date: Nov. 19, 2026

(54) MOBILITY NETWORK EVENT ANALYSIS

(71) Applicants: AT&T Communications Services India Private Limited, Karnataka (IN); AT&T Intellectual Property I, L.P., Atlanta, GA (US)

(72) Inventors: Karthikeyan Jagadeesan, BANGALORE (IN); Ashok Kumar, BENGALURU (IN); Sai Pranathi Sepuri, BANGALORE (IN); Bich Ngoc Nguyen, REDMOND, WA (US); Prince Paulraj, Coppell, TX (US); Debarati Chatterjee, KOLKATA (IN); Hemanth Kumar Subramanyam Bangalore, Plano, TX (US); Sumit Biswas, BANGALORE (IN); Richard Schmidt, Washington, PA (US); Ishita Roy, BENGALURU (IN); Himanshu Nanda, LUCKNOW (IN)

(73) Assignees: AT&T Communications Services India Private Limited, Karnataka (IN); AT&T Intellectual Property I, L.P., Atlanta, GA (US)

(21) Appl. No.: 19/677,003

(22) Filed: May 14, 2026

(51) Int. Cl. G06F 11/07

(52) U.S. Cl. CPC G06F 11/079; G06F 11/0715; G06F 11/0793

(57) ABSTRACT

Aspects of the subject disclosure may include, for example, determining weighted correlations for events based on frequency, time, and recency determinations related to pairs of events. Other aspects of the subject disclosure may include, for example, storing event resolution information as immutable records in a datastore. Other aspects of the subject disclosure may include, for example, prioritizing event handling based on weighted correlation determinations. Other embodiments are disclosed.

### FIELD OF THE DISCLOSURE

The subject disclosure relates to mobility network event analysis.

### BACKGROUND

Event monitoring technologies commonly collect alarms, logs, metrics, and other telemetry from distributed computing and network components and present the resulting events to operations personnel for review and response. In many deployments, determining whether events are related (e.g., whether multiple alerts arise from a shared initiating fault, a dependency chain, or a cascading failure) relies on manual investigation and/or rules-based correlation using static thresholds, pattern-matching rules, and predefined dependency maps.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of components of a system functioning within and in conjunction with the communications network of FIG. 1 in accordance with various aspects described herein.

FIG. 2B is a block diagram illustrating an example, non-limiting embodiment of components of an event monitoring system operating within or in conjunction with the system of FIG. 2A in accordance with various aspects described herein.

FIG. 2C is a flow chart diagram illustrating an example, non-limiting embodiment of the correlations analysis performed in the system of FIG. 2B in accordance with various aspects described herein.

FIG. 2D is an example, non-limiting embodiment of a co-occurrence matrix as produced and used in FIG. 2C in accordance with various aspects described herein.

FIG. 2E is an example, non-limiting embodiment of a time interval matrix as produced and used in FIG. 2C in accordance with various aspects described herein.

FIG. 2F is an example, non-limiting embodiment of a weighted matrix as produced and used in FIG. 2C in accordance with various aspects described herein.

FIG. 2G is a diagram illustrating an example, non-limiting embodiment of a weighted matrix updated process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for analyzing events in a mobility network. Other embodiments are described in the subject disclosure.

One or more aspects of the subject disclosure relate to reliably identifying that multiple events are manifestations of a common root cause.

One or more aspects of the subject disclosure relate to deemphasizing routine, low-risk, and/or easily addressed events that repeatedly occur during normal operations.

One or more aspects of the subject disclosure relate to mitigating the impact of high-volume common alerts and/or cascaded secondary alerts, thus mitigating alert fatigue in which multiple related events or common events drown out less common events and events that create fewer alerts, thereby delaying recognition and response to distinct coinciding failures and degrading operational responsiveness.

In one or more embodiments, event correlation is determined between pairs of events using multiple relationship measures derived from historical event observations. In such embodiments, a processing system retrieves instances of events from a community of events and determines, for a first event and a second event, a frequency with which instances of the first event and instances of the second event occur within a window of time, a time-related measure characterizing how temporally close together instances of the first event and instances of the second event occur, and a recency-related measure characterizing how recently the frequency-related and time-related measures were determined or observed. In such embodiments, these measures are combined to produce a correlation determination for the first event and the second event, and, upon receiving an alert representing another instance of the first event, a likelihood is predicted that an alert representing another instance of the second event will be received within a time window, whereupon a corrective action is initiated based on the predicted likelihood.

In one or more embodiments, event handling is performed using multiple AI models operating in a staged workflow in which high-impact events are routed for correlation analysis using historical event-resolution records. In such embodiments, a processing system receives a first instance of a first event, retrieves, from a datastore, data comprising instances of a plurality of events and associated resolutions, and determines, based on the retrieved data and the first instance, that the first instance corresponds to a high-impact event. In such embodiments, responsive to determining that the first instance corresponds to a high-impact event, the processing system sends the first instance to a second AI model that performs correlation analysis of the first event with the plurality of events using the first instance, thereby enabling prioritization of analysis resources toward events likely to be service-impacting.

In one or more embodiments, one or more AI models cooperate to integrate correlation prediction with additional operational context for summarization and persistent recording. In such embodiments, an AI model receives a correlation prediction indicating a likelihood that, as a result of a first instance of a first event arising, a second instance of a second event will occur within a window of time, retrieves error information from a datastore, and receives additional event information associated with a monitored environment. In such embodiments, the AI model sends the correlation prediction, the error information, and the additional event information to a second AI model for summarization and storage into a datastore, thereby enabling a consolidated operational record suitable for subsequent troubleshooting, audit, and reinforcement of future event handling.

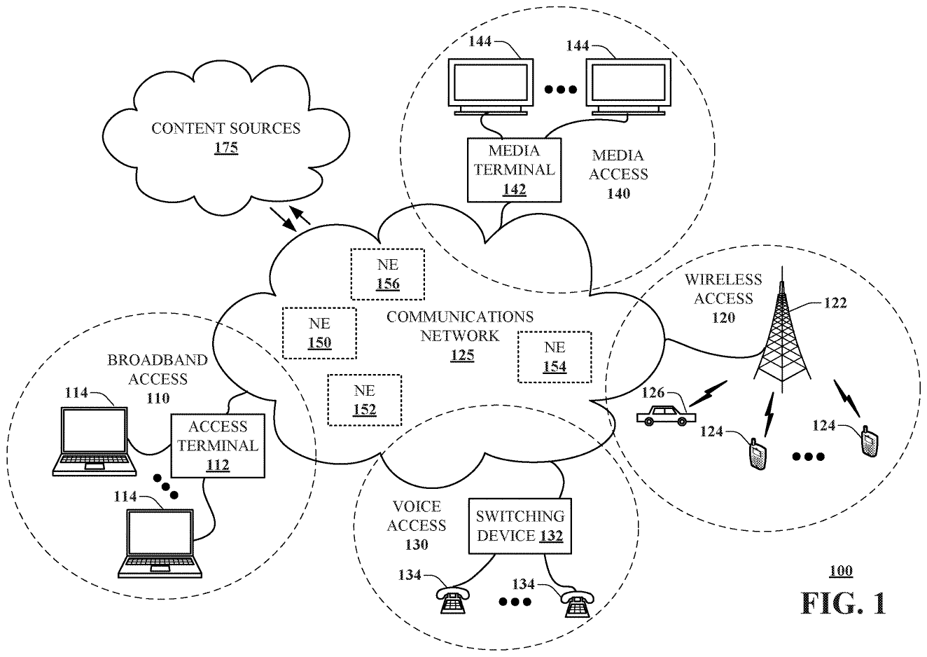

Referring now to FIG. 1, a block diagram is shown illustrating an example, non-limiting embodiment of a system 100 in accordance with various aspects described herein. For example, events analyzed in accordance with the systems and methods discussed herein may be produced by one or more components of system 100. Such events may themselves be analyzed using components deployed as part of system 100, including, for example, within communications network 125. Communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

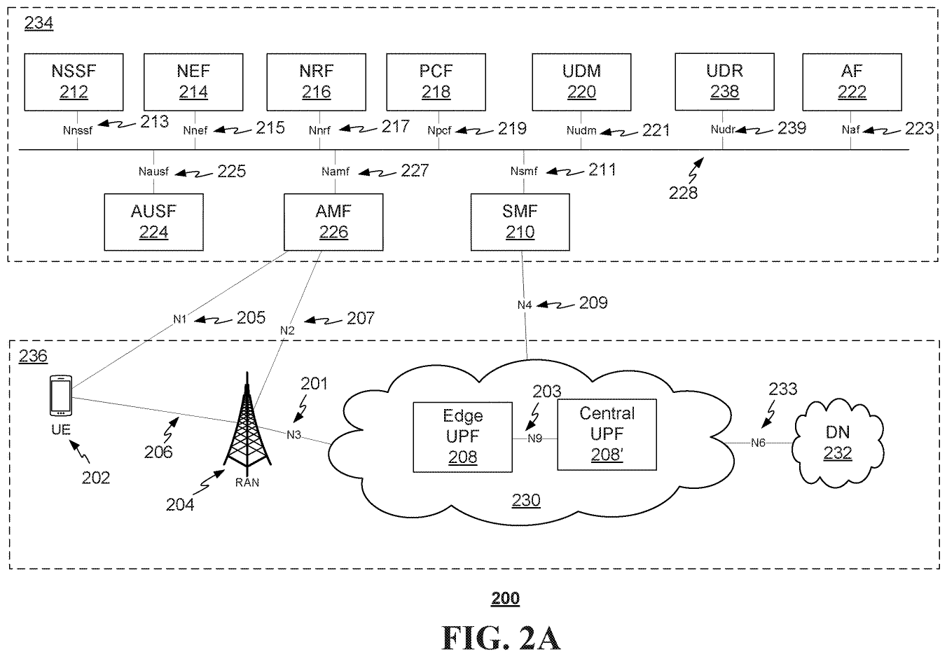

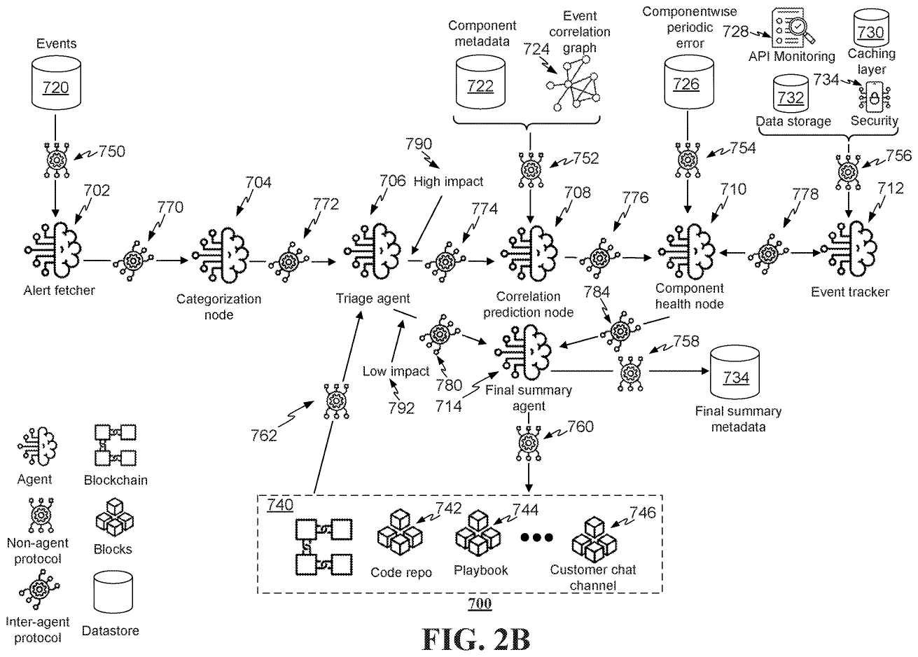

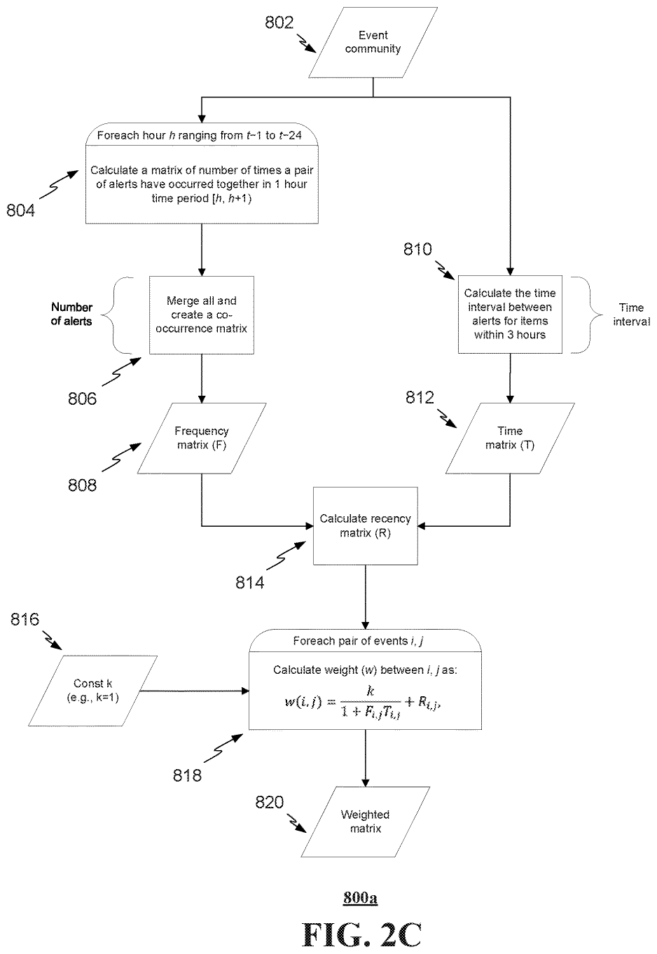

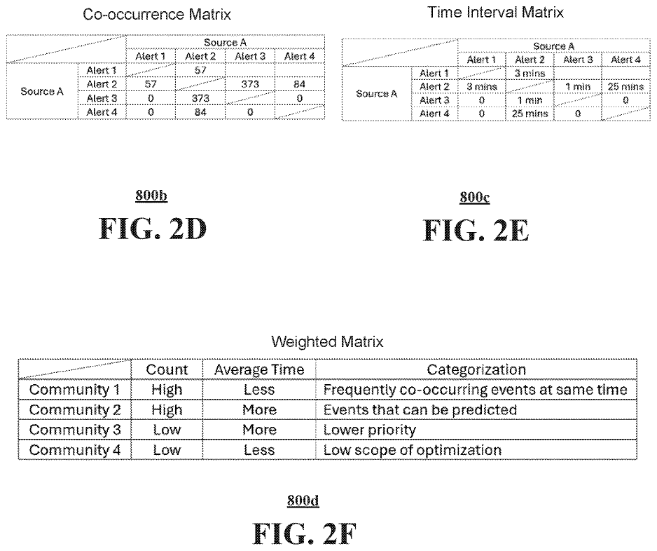

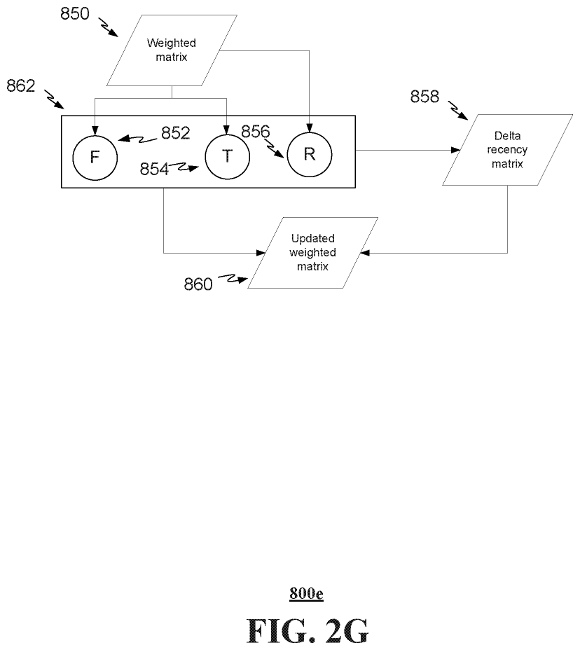

FIG. 2A is a block diagram illustrating an example, non-limiting embodiment of a system functioning within the communication network of FIG. 1 in accordance with various aspects described herein. Specifically, FIG. 2A provides the 5G core and access architecture context for FIG. 1 by illustrating, at a more detailed level, how a system functioning within the communications network 125 can be realized as 5G network 200 with control-plane and user-plane separation. User Equipment (UE) 202 and Radio Access Network (RAN) 204 in FIG. 2A correspond to endpoint and access portions depicted generally in FIG. 1, while control plane 234, user plane 236, and Data Network (DN) 232 of FIG. 2A correspond to core network and external network portions of communications network 125 in FIG. 1.

FIG. 2A depicts 5G network 200, which includes User Equipment (UE) 202. UE 202 communicates with Radio Access Network (RAN) 204 over over-the-air (OTA) interface 206. UE 202 can be any mobile device capable of establishing 5G sessions, and RAN 204 can be a Next Generation Radio Access Network (NG-RAN) that provides radio connectivity and forwards signaling and user-plane traffic to the core. Signaling between UE 202 and the Access and Mobility Management Function (AMF) 226 can be supported via N1 interface 205 and/or UE 202 can use tunneled N2 interface 207. Collectively, these signaling paths allow 5G control plane 234 to establish and manage registrations, sessions, mobility events, and policy enforcement for UE 202.

Control plane 234 is illustrated as a set of network functions coupled to control plane bus 228, which represents service-based communication pathways among network functions. AMF 226, which connects to control plane bus 228 via Namf interface 227, provides mobility management and registration functions for UE 202. AMF 226 interfaces to Authentication Server Function (AUSF) 224 using Nausf interface 225 for authentication-related messaging. AMF 226 also interfaces to Session Management Function (SMF) 210 via Nsmf interface 211 to coordinate session establishment, modification, and release. SMF 210 can interface with Policy Control Function (PCF) 218 through Npcf interface 219 to obtain policy rules and policy decisions that influence session behavior, quality of service, and access control.

FIG. 2A further depicts additional service-based control plane functions that participate in session lifecycle and service exposure. Network Slice Selection Function (NSSF) 212 can be used to assist selection of slice-specific behaviors and can be accessed via Nnssf interface 213. Network Exposure Function (NEF) 214 can provide exposure of core capabilities and events to external application functions and can be accessed via Nnef interface 215. Network Repository Function (NRF) 216 can provide discovery and registration services for network functions and can be accessed via Nnrf interface 217. Application Function (AF) 222 can represent an external or internal service that interacts with core policy and exposure mechanisms and can be accessed via Naf interface 223. These functions, as depicted, represent a typical operational setting in which service-based interfaces and control-plane message flows can generate high volumes of telemetry, alarms, and correlated effects during degradations.

Unified Data Management (UDM) 220 and Unified Data Repository (UDR) 238, which are accessed through Nudm interface 221 and Nudr interface 239 respectively, serve as a key data backbone for these and other functions of 5G networks. UDM 220, in particular, can be used by various 5G functions to access, store, and update subscriber-related and policy-related data. UDM 220 can depend upon UDR 238, which acts as a persistent data service for structured subscriber data and policy-related data access. In one or more embodiments, UDM 220 provides front-end processing for UDR 238 by receiving service-based requests from other network functions, performing request validation and authorization, applying data-model and policy logic, and translating the requests into corresponding UDR 238 read and write operations over Nudr interface 239. Such front-end processing is important-many of the functions supported can be performance-sensitive and availability-sensitive because they can affect authentication, authorization, session establishment, and mobility procedures. UDR 238 can also be used to store information such as operational abnormalities (e.g., latency spikes, error bursts, storage saturation, cache failure, security-related failures, and other automated or manually created alerts), which can manifest as cascaded control plane 234 failures across other network functions coupled to control plane bus 228. Although the analysis and management of such operational abnormalities can be executed in other parts of the communications network (for example, as part of the operations of UDM 220 or in network elements not depicted in FIG. 2A), UDR 238's central position as a persistent data store can support both the deployment and efficient operation of the disclosed method and system.

In various deployments, UDR 238 can be implemented as a distributed database cluster and can be coupled to one or more caches, security modules, and storage layers that are not separately depicted in FIG. 2A but are part of the operational behavior of UDR 238.

User plane 236 is shown as being anchored by one or more User Plane Functions (UPFs), including edge UPF 208 and a central UPF 208′, which represent different placement options or configurations for user-plane processing. RAN 204 can interface with a selected UPF using N3 interface 201, and a UPF can interface to another UPF using N9 interface 203. A UPF can interface to Data Network (DN) 232 using N6 interface 233, enabling user traffic to reach external networks and services. SMF 210 can control user-plane forwarding behavior and rules by interfacing with a UPF using N4 interface 209, thereby tying control plane 234 to user plane 236. A degradation in control-plane data services can indirectly disrupt user plane 236 by delaying or failing session control operations that drive user-plane rule updates, resource allocation, or policy enforcement.

In one or more embodiments, control-plane data services, including UDR 238 and/or UDM 220, store, expose, and/or correlate control-plane indicators with user-plane indicators obtained from edge UPF 208 and/or central UPF 208′, thereby enabling monitoring, analysis, and management of abnormalities affecting user plane 236. In such embodiments, correlated control-plane records can be used to detect user-plane degradation conditions, infer a root cause, and select or trigger corrective actions affecting user-plane forwarding behavior, capacity allocation, or session distribution.

One or more embodiments operate within the architecture of FIG. 2A by enabling proactive monitoring and health management for core components, particularly through use of UDR 238 and/or UDM 220. For example, logs and metrics from UDR 238, UDM 220, PCF 218, NRF 216, NEF 214, and SMF 210 can provide event streams that reflect component stress, abnormal states, or emerging incidents. These event streams can be correlated with each other and/or with user-plane indicators from Edge UPF 208 and Central UPF 208′ (e.g., session establishment failures or throughput anomalies) to distinguish local component failures from broader systemic issues. In addition, because service-based interfaces such as Nudr interface 239 and Nudm interface 221 can be implemented using web-based Application Programming Interface (API) mechanisms, operational monitoring can include application-layer and transport-layer indicators to support anomaly detection and root-cause inference.

All reference numbers depicted in FIG. 2A are therefore described as components and interfaces that form the technical environment in which the subject disclosure's monitoring and corrective-action framework operates. The 5G network 200 includes the user equipment 202, the radio access network 204, the over-the-air interface 206, the edge user plane function 208, the central user plane function 208′, the session management function 210, the network slice selection function 212, the network exposure function 214, the network repository function 216, the policy control function 218, the unified data management function 220, the application function 222, the authentication server function 224, the access and mobility management function 226, the control plane bus 228, available user plane functions 230, the data network 232, the control plane 234, the user plane 236, the uniform data repository 238, and the Nnssf interface 213, the Nnef interface 215, the Nnrf interface 217, the Npcf interface 219, the Nudm interface 221, the Naf interface 223, the Nausf interface 225, the Namf interface 227, the Nsmf interface 211, the non-radio signaling interface from user equipment to access management function 205, the tunneled interface from user interface to access management function 207, the radio access network interface to selected user plane function 201, the N4 interface 203, the N9 interface 209, the N6 interface 233, and the Nudr interface 239.

In some embodiments, the monitored target data is not limited to data found in or marked for storage in UDR 238, but instead includes one or more other control-plane network functions or user-plane functions. In such an embodiment, events are collected from the relevant service-based interfaces, such as Nsmf interface 211, Namf interface 227, Npcf interface 219, Nnrf interface 217, Nnef interface 215, and/or Nnssf interface 213. In some embodiments, proactive monitoring incorporates user-plane indicators and remedial actions directed to available user plane functions 230, including Edge UPF 208 and Central UPF 208′. For example, anomalous session traffic behavior can be inferred from N3 interface 201, N9 interface 209, and/or N6 interface 233, N1 interface 205, and/or N2 interface 207.

In some embodiments, the disclosed system and methods are implemented in a distributed deployment where event collection and analytics are partitioned by network slice, by geographic region, or by tenant, such that monitoring for UDR 238 is performed using separate analytic instances per slice determined through NSSF 212. In such embodiments, inputs derived from slice identifiers and slice-specific policies can be used to modulate alert thresholds and action eligibility, reducing cross-slice interference and allowing differentiated operational handling.

Although described primarily with respect to 5G network architectures and associated core network functions, one or more embodiments are likewise applicable to, and can be deployed in, Sixth Generation (6G) and other next-generation telecommunications systems-particularly with respect to network functions that are implemented as cloud-native, service-oriented, and/or virtualized components that generate telemetry, alarms, and performance indicators across control-plane and user-plane domains. In such embodiments, the event ingestion, categorization, triage, correlation, health assessment, and remediation techniques described herein can be applied to analogous 6G or other telecommunications control-plane data services and user-plane functions, including correlating events across distributed network slices, edge computing nodes, and disaggregated radio access components, and executing automated corrective actions using operational tooling interfaces, thereby improving resiliency, availability, and operational efficiency in heterogeneous next-generation deployments.

The disclosed systems and methods improve the functioning of computer-implemented network operations for 5G network 200 by enabling earlier detection and structured handling of abnormal behavior that can propagate through service-based interfaces. By structuring the monitored environment around explicit control plane 234 and user plane 236 touchpoints, the time required to localize failures, reduce redundant alarms caused by cascading effects, and improve system availability by enabling timely corrective actions that stabilize impacted components.

One or more embodiments mitigate alert fatigue in complex service-based core deployments by converting high-volume, overlapping alarm streams into structured incident groupings that reflect underlying operational coupling. For example, in environments where a degradation in a shared dependency (e.g., a data service, cache service, storage subsystem, security subsystem, or inter-network-function interface) produces cascaded secondary alarms across multiple network functions, the disclosed systems and methods can identify relationships among the alarms and treat a set of related alarms as an aggregated incident signature, rather than as unrelated independent failures. This reduces the likelihood that secondary alarms obscure distinct coinciding failures that occur contemporaneously but arise from different root causes.

One or more embodiments further reduce alert fatigue by prioritizing processing of rare, severe, or anomalous events while deprioritizing repetitive, low-signal events that are known or expected, thereby reducing wasted computational resources and reducing unnecessary operator notifications. In such embodiments, event categorization and triage logic can suppress redundant alerts that are attributable to a shared initiating fault, while maintaining visibility into outlier events that do not align with known correlation structures, thereby improving detection of distinct coinciding failures that could otherwise be masked by a dominant cascading failure pattern.

One or more embodiments, by mitigating alert fatigue and improving the separation of root-cause-related alarms from independent coincident alarms, improve responsiveness of operational workflows, reducing time-to-localization, and improving stability of automated remediation by enabling corrective actions to be directed to a most-likely initiating component rather than to multiple downstream symptoms. This provides a technical improvement in computer-implemented network operations by reducing redundant alarm handling, reducing time spent on false correlations, and enabling faster convergence on corrective actions in high-volume telemetry conditions.

Further, one or more embodiments provide a technical improvement in operational automation by integrating health assessment and event correlation with actionable remediation pathways that can be applied to concrete network functions, such as the session management function 210 and the user plane functions 208 and 208′. This enables remediation workflows to be grounded in measurable system indicators (e.g., error rates, latency, saturation) and executed through operational tools, thereby reducing manual intervention and improving repeatability. Such improvements are particularly relevant in cloud-native deployments where frequent scaling events and transient failures can otherwise create noisy and ambiguous operational signals.

FIG. 2A further provides the operational component landscape that is monitored and acted upon by the workflow shown in FIG. 2B, where events and health signals originate from components such as the unified data repository 238, the unified data management function 220, the policy control function 218, and the session management function 210. In that sense, FIG. 2A identifies where, within the 5G network 200, the event sources and action targets exist, while FIG. 2B illustrates a representative agentic workflow that consumes those events and produces remediation actions.

FIG. 2A further provides the operational component landscape that is monitored and acted upon by the workflow shown in FIG. 2B, described below, where events and health signals originating from components are routed for stored in UDR 238 through UDM 220. Such events and health signals can come from, UDR 238 or UDM 220 themselves, from other control-plane functions and elements such as PCF 218 and SMF 210, and/or from user-plan functions and elements such as Edge UPF 208, Central UPF 208′, RAN 204, UE 202, and/or a network element of DN 232. Thus, FIG. 2A identifies examples of where, within 5G network 200, the event sources and action targets exist, while FIG. 2B, as detailed below, illustrates a representative agentic workflow that consumes those events and produces remediation actions.

FIG. 2B depicts workflow 700 that operates as an agentic monitoring, correlation, and remediation pipeline for events generated by components of a mobile network core, such as a 5G core network. In this figure, a plurality of software agents cooperate to intake operational events, classify and prioritize those events, correlate the events with historical patterns and component context, and generate actionable remediation outputs. Workflow 700 is shown as a sequence of interconnected functional nodes that communicate using one or more protocol types, including non-agent protocol interfaces and inter-agent protocol interfaces, and that further interact with supporting data stores and operational tooling. Workflow 700 can be deployed in, or in association with, a control-plane environment (e.g., a UDR) and can be executed by one or more computing systems that provide processing resources and memory resources for implementing the agent logic and the supporting storage and analytics elements.

At an input side of workflow 700, event datastore 720 stores operational events that can include logs, alarms, telemetry samples, performance counters, error codes, exception traces, rate-limit indicators, latency indicators, and other observability signals produced by monitored components. Event datastore 720 can be populated by existing monitoring and logging systems or by component-generated instrumentation. Event datastore 720 can also include time-stamped event records for later retrieval. Non-agent protocol interface 750 provides an integration mechanism by which alert fetcher 702 retrieves event records from event datastore 720. Alert fetcher 702 can normalize, filter, and/or batch incoming events, and alert fetcher 702 can generate preliminary summaries (e.g., a concise textual synopsis and a structured object representation) for downstream processing by other agents in workflow 700. In some implementations, alert fetcher 702 can apply deduplication, rate limiting, or sampling so that repetitive, low-signal alerts do not dominate subsequent correlation processing.

In one or more embodiments, event datastore 720 stores events on a temporary basis. For example, event datastore 720 can retain an event only until retrieval by the alert fetcher 702 via the non-agent protocol interface 750. In such embodiments, a time-out can be associated with temporary storage such that, if alert fetcher 702 fails to retrieve an event within a configured retention period, event datastore 720 can delete the event, overwrite the event, or otherwise render the event unavailable for general retrieval. In further embodiments, an event can be retained after occurrence until such time as alert fetcher 702 retrieves the event, thereby ensuring that alert fetcher 702 can consume the event even when alert fetcher 702 is subject to transient delays or intermittent connectivity.

In one or more embodiments, event datastore 720 stores events on a permanent or semi-permanent basis. For example, an event can remain stored in event datastore 720 indefinitely, or for an extended retention period, even after being retrieved by alert fetcher 702 via non-agent protocol interface 750. In such embodiments, removal of an event from event datastore 720 can occur upon receipt of a removal command by event datastore 720, upon a time-out, or upon a capacity threshold being met, such as a storage utilization threshold or an event-count threshold. In one or more embodiments, events marked for removal can remain available to alert fetcher 702 for a limited period, while appearing to other readers as having been removed, thereby enabling alert fetcher 702 to complete ingestion without reintroducing general availability of obsolete records.

In one or more embodiments, removal of an event from event datastore 720 does not take immediate full effect. For example, event datastore 720 can mark an event for later removal, move the event to a temporary holding location, or place the event into a soft-deleted state while deferring full deletion. In such embodiments, events marked for later removal can be fully deleted when storage capacity needs to be restored, when a background compaction process executes, or during lulls in usage, thereby smoothing computational demands and input/output overhead, and reducing interference with active ingestion and retrieval operations performed by alert fetcher 702.

In one or more embodiments, event datastore 720 performs one or more preprocessing functions to reduce downstream processing demands. For example, event datastore 720 can normalize event records into a common schema, can deduplicate repeated events, can apply rate limiting, and/or can assign or update event metadata (e.g., component identifiers, timestamps, or severity tags) prior to retrieval by alert fetcher 702. In such embodiments, alert fetcher 702 can receive more uniform and lower-noise event inputs, improving the efficiency and consistency of subsequent categorization, triage, and correlation processing.

In one or more embodiments, event datastore 720 compresses events and provides events in compressed form, uncompressed form, or partially compressed form to alert fetcher 702, thereby enabling tradeoffs between bandwidth consumption and computational overhead. In such embodiments, compression and decompression can take place at event datastore 720, at alert fetcher 702, or at another component in the workflow, and decompression can be deferred until needed for a particular analytic operation. Further, compression can be selectively applied, such as compressing highly repetitive events, compressing events only during high-volume conditions, or compressing event payloads while leaving header metadata uncompressed to support efficient filtering and routing by alert fetcher 702.

Alert fetcher 702 passes event information to categorization node 704 using inter-agent protocol interface 770. Inter-agent protocol interface 770 can correspond to any communications protocol for interactions among AI agents that supports task submission, long-running task updates, and structured artifact exchange. Categorization node 704 analyzes each event and identifies patterns such as daily trends, event frequency, statistical deviations from baseline, severity level, and contextual attributes (e.g., component identifiers, interface identifiers, and tenant or slice indicators where available). Based on this analysis, categorization node 704 can assign a priority class (e.g., escalate, monitor, or ignore) and can prepare a formatted report and a structured representation suitable for consumption by triage agent 706. Categorization node 704 thereby converts raw observability signals into a higher-level operational classification that is used to control which events proceed to deeper correlation and remediation logic.

Triage agent 706 receives categorized events from categorization node 704 via inter-agent protocol interface 772 and performs prioritized investigation and routing. In workflow 700, triage agent 706 can implement a router-executor-summarizer pattern in which triage agent 706 selects one or more next actions based on event class, operational context, and learned historical handling. Triage agent 706 can determine whether an event should proceed along high-impact path 790 or low-impact path 792, where high-impact path 790 corresponds to events that are rare, severe, escalating, or otherwise likely to cause service disruption, and low-impact path 792 corresponds to events that are known, repetitive, low-severity, or otherwise not requiring immediate or non-routine corrective action. To support this decision-making, triage agent 706 can consult blockchain 740, which stores immutable incident-level records, and that can include prior chain-of-thought records, mitigation steps, and outcome metadata associated with prior incidents. Non-agent protocol interface 762 provides a mechanism for triage agent 706 to access blockchain 740, allowing the triage agent 706 to incorporate historical reasoning and verified action sequences as guardrail context during triage.

When triage agent 706 routes an event along high-impact path 790, workflow 700 proceeds to correlation logic driven by correlation prediction node 708. Correlation prediction node 708 can receive the high-impact event context from triage agent 706 and can further ingest historical correlation structures, including event correlation graph 724 and component metadata from component metadata datastore 722. Event correlation graph 724 can represent learned relationships among event types, event sources, and temporal co-occurrence structures, including graph edges weighted by frequency of co-occurrence, time-interval relationships, and recency factors derived from historical event windows. Non-agent protocol interface 752 provides a mechanism for correlation prediction node 708 to access event correlation graph 724 and component metadata datastore 722, enabling correlation prediction node 708 to determine whether an observed event belongs to a known community of events, whether the event is likely to trigger other events, and whether a causal hypothesis can be synthesized from historical evidence. In the subject disclosure, this correlation logic can be aligned with the event community builder processes illustrated in other figures, in which weighted matrices and recency-adjusted relationships produce clusters or communities that are then used in real-time inference.

Downstream of correlation prediction node 708, component health node 710 evaluates the operational health of one or more implicated components. The component health node 710 can ingest componentwise periodic error information from componentwise periodic error datastore 726, and a non-agent protocol interface 754 can provide access to the componentwise periodic error datastore 726. Componentwise periodic error datastore 726 can store error-rate time series, latency distributions, saturation indicators, and other periodic health measures partitioned by component or subcomponent (e.g., an API layer, a caching layer, a data storage layer, or a security layer). Component health node 710 can compute trends (e.g., increasing error rates over the last n hours), identify persistent degradation versus transient spikes, and generate summaries that characterize the present health of the implicated components. Component health node 710 can then provide these health summaries back into workflow 700 to support downstream remediation selection.

Event tracker 712 collects and maintains additional operational context such as API monitoring outputs, cache performance outputs, data storage utilization outputs, and security status outputs. In FIG. 2B, API monitoring system 728, caching layer datastore 730, data storage datastore 732, and security datastore 734 are shown as sources of such context. Non-agent protocol interface 756 provides a mechanism by which event tracker 712 can access one or more of API monitoring system 728, caching layer datastore 730, data storage datastore 732, and security datastore 734. Although depicted as a single interface, in one or more embodiments multiple non-agent interfaces may be used. Event tracker 712 can correlate the current event with other events occurring in the same time window and across other components, thereby capturing cross-component propagation patterns that can be especially relevant in service-based core architectures where one component's abnormal behavior can induce errors elsewhere. In some implementations, event tracker 712 can also interface with a caching layer or intermediate store to reduce repeated retrieval overhead when multiple agents consult the same external telemetry sources within a short time interval.

Outputs of correlation prediction node 708, component health node 710, and event tracker 712 are then utilized by final summary agent 714, which acts as an action selection and synthesis component. Final summary agent 714 can receive investigative summaries and causal hypotheses through an inter-agent protocol interface 780, and can generate an after-action report that includes grouped recommendations, prioritized remediation actions, and supporting evidence for operational stakeholders. Final summary agent 714 can store final summary metadata to datastore 734, the datastore 734 can maintain structured records of the remediation decision, the implicated components, the supporting evidence, and outcome tracking fields. Final summary agent 714 can also write a secure and immutable record of a successful mitigation's reasoning and action sequence to the blockchain 740, thereby providing a reinforcement mechanism in which subsequent triage can consult prior successful handling. In addition, final summary agent 714 can invoke operational tools and external systems through one or more non-agent protocol interfaces, including non-agent protocol interface 760 that enables the addition of information to code repository 742, playbook 744, and customer chat channel 746. By accessing code repository 742, final summary agent 714 can retrieve relevant diffs, configuration files, or deployment artifacts; by accessing playbook 744, final summary agent 714 can trigger and/or record execution of predefined runbooks such as restarting services, scaling instances, flushing caches, rotating credentials, adjusting throttles, or applying configuration changes (and record the outcome of such execution); and by accessing customer chat channel 746, final summary agent 714 can notify stakeholders, request human confirmation when operational policy requires approval, and/or maintain a record of interactions that can be used, for example, to predict whether what future alerts relate to and how to address them effectively.

Workflow 700 further includes inter-agent protocol interfaces 774, 776, and 778 that represent additional agent-to-agent communication paths among triage agent 706, correlation prediction node 708, final summary agent 714, and component health node 710. In some configurations, these inter-agent protocol interfaces 774, 776, and 778 enable asynchronous task execution and streaming updates, such that final summary agent 714 can receive partial artifacts from correlation prediction node 708 or component health node 710 while long-running evidence gathering is in progress. The presence of multiple protocol types, including non-agent protocol interfaces 750, 752, 754, 756, 758, 760, and 762, allows workflow 700 to operate in a heterogeneous environment in which some systems expose traditional APIs, databases, or monitoring endpoints, while other systems operate as peer agents capable of structured negotiation and artifact exchange. Workflow 700 therefore embodies an operational architecture that reduces alert fatigue by using categorization node 704 and triage agent 706 to prioritize processing, improves root-cause localization by combining event correlation graph 724 with present-time health evaluation via component health node 710, and enables practical remediation by integrating playbooks 744, code repository access 742, and stakeholder communication via customer chat channel 746.

FIG. 2B further includes low-impact path 792 that enables triage agent 706 to route non-critical events toward a lighter-weight handling flow that can still produce summaries or monitoring records without initiating full correlation and remediation. In some implementations, low-impact events can be aggregated, rate-limited, or stored for later trend analysis, thereby maintaining operational awareness while avoiding unnecessary resource consumption. Workflow 700 thus supports both proactive response to emerging high-impact incidents and efficient background processing of routine operational noise, while maintaining a secure historical record via blockchain 740 to support reinforcement of prior successful handling patterns.

In some embodiments, event datastore 720 is replaced or augmented with multiple event datastores 720 partitioned by network slice, geographic region, tenant, or component family, and alert fetcher 702 is configured to query one or more of partitioned event datastores 720 based on a routing key contained in event metadata. In such embodiments, separate instances of categorization node 704 and triage agent 706 can be deployed per partition to provide isolation and scalability, while sharing a common event correlation graph 724 or maintaining separate event correlation graphs 724 per partition.

In other embodiments, blockchain 740 is replaced by an append-only tamper-evident log stored in a secure datastore, and non-agent protocol interface 762 is replaced by a secure logging interface that enforces write-once semantics and cryptographic integrity checks. In such embodiments, triage agent 706 and final summary agent 714 still record incident-level reasoning and outcomes, but such implementations leverage cryptographic hashing, digital signatures, or secure enclave-based attestation instead of a distributed blockchain network.

In some embodiments, component health node 710 is expanded into multiple specialized health agents, each dedicated to a respective operational layer, such as an API health agent that interfaces with API monitoring system 728, a caching health agent that interfaces with the caching layer datastore 730, a storage health agent that interfaces with the data storage datastore 732, and a security health agent that interfaces with the security datastore 734. In such an embodiment, the inter-agent protocol interfaces 776 and 778 can be used to aggregate layer-specific health artifacts into the final summary agent 714, allowing more granular diagnostics and more targeted remediation playbooks 744.

In one or more embodiments, one or more of the inter-agent protocol interfaces (e.g., the inter-agent protocol interfaces 770, 772, 774, 776, 778, and 780) include, or are based on, an Agent-to-Agent protocol that enables structured communications among software agents, such as Agent-to-Agent (A2A) protocol for agent communications introduced by Google®. In such embodiments, an agent (e.g., alert fetcher 702, categorization node 704, triage agent 706, correlation prediction node 708, component health node 710, and/or final summary agent 714) can operate as an A2A client agent that submits an agent task to another agent operating as an A2A server agent, and can receive back task results, intermediate status updates, and artifacts generated during task execution. In one or more embodiments, the inter-agent protocol interfaces based on A2A support long-running asynchronous tasks and streaming or push-style updates (e.g., via a subscribe-notify channel), such that partial findings (e.g., preliminary correlation hypotheses or partial health summaries) can be transmitted to a downstream agent before a task is fully completed.

In one or more embodiments, use of A2A-based inter-agent protocol interfaces enables agents to advertise and discover capabilities through a machine-readable capability description, such as an agent card that identifies supported skills, input types, output types, authentication requirements, and an endpoint for communications. In such embodiments, triage agent 706 can select one or more downstream agents based on the capability description and can route a given event context to a selected downstream agent, including selecting a specialized agent for correlation processing, a specialized agent for component health assessment, or a specialized agent for summarization or reporting. In one or more embodiments, communications between agents via the A2A-based inter-agent protocol interfaces use structured message parts that enable transmission of text, structured data objects (e.g., JavaScript Object Notation (JSON)), and file or resource references, thereby enabling workflow 700 to exchange both human-readable summaries and machine-actionable context objects.

Similarly, in one or more embodiments, one or more of the non-agent protocol interfaces (e.g., non-agent protocol interfaces 750, 752, 754, 756, 758, 760, and/or 762) can include, or be based on, an interface for exchanging data between AI agents and external elements. Such non-agent protocol interfaces can include, but are not limited to, the Model Context Protocol® (MCP) promulgated by LF Projects for standardized tool and context access. In such embodiments, an agent can act as an MCP host/client and can establish a connection to one or more MCP servers that expose tools and resources associated with operational systems, including event datastore 720, component metadata datastore 722, event correlation graph 724, componentwise periodic error datastore 726, API monitoring system 728, caching layer datastore 730, data storage 732, security system 734, and/or blockchain 740 (including, but not limited to, code repository 742, playbook 744, and/or customer chat channel 746). In one or more embodiments, MCP-based non-agent protocol interfaces expose tools via defined input schemas and return results as structured responses, enabling an agent to invoke operational actions (e.g., retrieving logs, querying metrics, initiating a runbook, fetching configuration data, or generating notifications) through a consistent protocol abstraction rather than through bespoke per-system adapters.

In one or more embodiments, MCP-based non-agent protocol interfaces further support discovery of available tools and resources, and support receipt of asynchronous notifications when data or tool availability changes, thereby enabling agents in workflow 700 to react to evolving operational conditions without continuous polling. For example, correlation prediction node 708 can use an MCP-based non-agent protocol interface to retrieve correlation context from the event correlation graph 724 and component metadata from component metadata datastore 722, while component health node 710 can use an MCP-based non-agent protocol interface to retrieve periodic health indicators from componentwise periodic error datastore 726, and final summary agent 714 can use an MCP-based non-agent protocol interface to invoke an operational runbook exposed by playbook 744. In one or more embodiments, the combination of A2A-based inter-agent protocol interfaces and MCP-based non-agent protocol interfaces allows workflow 700 to separate agent-to-agent reasoning and delegation from agent-to-tool execution and context retrieval, thereby improving modularity, interoperability, and extensibility of the operational automation pipeline.

In one or more embodiments, workflow 700 supports deployment of multiple inter-agent and/or non-agent protocols concurrently. For example, in addition to one or more open protocols used by inter-agent protocol interfaces 770, 772, 774, 776, 778, and/or 780 and non-agent protocol interfaces 750, 752, 754, 756, 758, 760, and/or 762, one or more components can utilize one or more proprietary or specialized protocols for selected communications, such as when a proprietary or specialized protocol provides higher efficiency, lower latency, improved stability, or enhanced operational control for interacting with a particular component or data source. In such embodiments, workflow 700 can select among available protocols based on component capabilities, measured performance, network conditions, or policy constraints.

In one or more embodiments, certain features may be accessed using one or more proprietary or specialized protocols, particularly when such features are not available through an open protocol such as A2A or MCP. For example, a proprietary or specialized protocol can expose additional telemetry fields, more granular authentication mechanisms, richer subscription and notification semantics, or specialized streaming formats for high-volume event ingestion, and such features can be utilized by one or more of the agents of workflow 700 to improve correlation accuracy, reduce overhead, or accelerate remediation. In such embodiments, open protocol usage can be retained for portability and interoperability, while proprietary or specialized protocol usage is selectively employed for performance- or feature-critical interactions.

In one or more embodiments, one or more components support multiple protocols simultaneously, thereby enabling interoperability with different agents and external systems that do not all support a single protocol. For example, a component can expose a first protocol endpoint for interactions with one class of agents and expose a second protocol endpoint for interactions with another class of agents or with external data systems, and workflow 700 can route requests accordingly. In such embodiments, workflow 700 can include protocol translation, protocol bridging, or dual-stack operation, enabling an agent to obtain data or execute operations via whichever protocol is supported by the target component while preserving overall workflow coherence across heterogeneous protocol domains.

In one or more embodiments, one or more components of workflow 700 interact with an agent that is not depicted in FIG. 2B using an inter-agent protocol interface, either instead of or in conjunction with one or more of the non-agent protocol interfaces 750, 752, 754, 756, 758, 760, and/or 762. In such embodiments, additional agents can provide intermediary functionality such as data filtration, abstraction, aggregation, feature extraction, normalization, or preliminary analysis prior to providing results to one or more of the agents of workflow 700, thereby reducing resource demands on the AI models executed by the agents of workflow 700. Further, in some embodiments, one or more external systems depicted as being accessed via a non-agent protocol interface can be accessed through an inter-agent protocol interface when an intermediary agent is used as a protocol bridge, security boundary, policy enforcement point, or tool orchestration service, including embodiments in which an external system requires interactions through an inter-agent protocol interface for controlled access, auditing, throttling, or asynchronous execution management.

Workflow 700 improves computer-implemented network operations by transforming raw operational telemetry into structured, prioritized, and correlated incident handling, thereby reducing redundant processing and reducing the computational and human burden associated with high-volume alert streams. By using categorization node 704 and triage agent 706 to filter and prioritize events prior to deeper correlation, workflow 700 reduces wasted computation on low-signal events and mitigates alert fatigue effects that can degrade operational response. The integration of historical correlation structures in event correlation graph 724 with present-time component degradation evaluation in component health node 710 enables faster localization of abnormalities within complex distributed systems, which improves the functioning of computing systems tasked with maintaining service availability and performance.

Workflow 700 further improves the technical field of automated remediation by coupling diagnostic outputs to operational tooling pathways through non-agent protocol interfaces 760 and playbook 744, enabling repeatable and policy-controlled corrective actions grounded in measurable health signals. By persisting successful mitigation reasoning and action sequences in immutable blockchain 740 and reusing those records in subsequent triage via triage agent 706, workflow 700 provides a reinforcement mechanism that increases consistency, reduces time-to-mitigation, and provides auditable provenance. These features collectively enhance the reliability and resilience of cloud-native network core platforms by enabling earlier detection of abnormal patterns, structured correlation across components, and coordinated remediation execution.

In one or more embodiments, although blockchain 740 is described as storing immutable incident-level records, other datastores can be used instead of, or in addition to, blockchain 740. For example, incident-level records can be stored in one or more topic datastores, relational databases, non-relational databases, directories, and/or file systems, including local or distributed storage systems. In such embodiments, triage agent 706 and/or final summary agent 714 can write incident-level records to the selected datastore and can retrieve incident-level records from the selected datastore for subsequent use in investigation, decisioning, reporting, and remediation selection.

In one or more embodiments, when incident-level records are stored using non-blockchain technologies, the records are stored in a manner that preserves immutability or otherwise provides tamper-evidence. For example, incident-level records can be stored with cryptographic signatures, cryptographic hashes, data watermarks, steganographic markers, encryption, or combinations thereof, such that unauthorized modification can be detected and/or prevented. In such embodiments, records can be stored as append-only logs, write-once objects, or versioned objects with integrity metadata, and access policies can prevent overwriting or deletion except under controlled retention procedures.

In one or more embodiments, integrity of incident-level records is supported or further supported by third-party verification of data integrity. For example, integrity metadata associated with an incident-level record can be periodically notarized, anchored, or attested by an external verification service, a separate trust domain, or an independent audit system, thereby enabling later validation that the incident-level record has not been altered. In such embodiments, the recorded incident-level data provides verifiable provenance for operational actions and supports repeatable use of prior incident handling while maintaining confidence that the stored record has not been corrupted.

In one or more embodiments, workflow 700 operates within the service-based 5G core environment depicted in FIG. 2A in which telemetry and events originate from core network functions and data services, including a UDR and related control-plane functions. In such embodiments, event datastore 720 can store events and logs generated by control-plane functions and interfaces, and user-plan elements, depicted in FIG. 2A, and remediation actions invoked by the final summary agent 714 can be applied to one or more of those functions using operational runbooks and tooling. Further workflow 700 can ingest events from network elements and service platforms corresponding to the communications network context depicted in FIG. 1, while the outputs of final summary agent 714 can trigger corrective actions that stabilize services delivered across broadband access, wireless access, voice access, or media access environments.

FIG. 2C depicts flowchart 800a that illustrates a graph-construction workflow for deriving an event correlation representation from historical event data. The processes shown in FIG. 2C can be performed periodically or on-demand to build and refresh an event correlation graph used by downstream analytics and agentic workflows.

Flowchart 800a begins with information from event community 802, which represents a collection of event types and/or event instances observed in a monitored system, such as a control-plane environment of a mobile network core. Event community 802 can be defined over a historical observation window, and can be seeded by selecting a set of event identifiers, alert identifiers, or event categories that are to be correlated. In some implementations, event community 802 can be limited to events associated with a particular component family (e.g., an application programming interface layer, a caching layer, a data storage layer, or a security layer), while in other implementations, event community 802 spans multiple components and multiple layers so that cross-component propagation can be represented.

A first branch of flowchart 800a includes step 804 in which, for each hour h in a time range, a count is computed for the number of times a pair of events occurred together within a corresponding time interval. In one example, step 804 can compute, for each pair of events i and j, the number of co-occurrences within each one-hour bin [h, h+1), thereby producing a set of per-hour pairwise co-occurrence counts. These per-hour counts can be computed by scanning time-stamped events stored in an event repository and incrementing a counter when a first event and a second event occur within the same bin or within an overlap condition defined for the bin. The output of step 804 is then aggregated in step 806, which merges the per-hour results to create a co-occurrence matrix that encodes, for each ordered pair of events, a co-occurrence count across the selected observation window. In the subject disclosure, the co-occurrence matrix produced by step 806 can represent frequency matrix 808, where frequency matrix 808 stores, for each event pair, a cumulative or otherwise aggregated count of how often the event pair occurs together.

A second branch of flowchart 800a includes step 810, in which a time-interval relationship between event pairs is calculated. These relationships can characterize how temporally separated events are when they are related. In one example, step 810 calculates, for event pairs within a predefined time interval window, a statistic representing the time difference between occurrences of the paired events. Non-limiting example statistics include averages, medians, trimmed means, percentiles, minimums, maximums, and rankings. The time interval window in step 810 can be configured as a fixed duration, such as three hours, or as another duration based on the system's operational characteristics, and the computation can consider both forward and backward time deltas as applicable. The output of step 810 is stored as time matrix 812, where time matrix 812 encodes, for each event pair, a representative time interval value such as an average, median, trimmed mean, percentile, minimum, maximum, ranking, or another statistic describing how quickly one event tends to follow another event.

Flowchart 800a further includes step 814 in which a recency matrix is computed to bias the correlation representation toward more recent observations. In the subject disclosure, the recency matrix computed in step 814 can represent whether an event-pair relationship has occurred within a recent time horizon (e.g., a short-term horizon such as days or weeks) and can also incorporate longer-term decay so that stale relationships are down-weighted. The recency matrix computed in step 814 can be derived from the same time-stamped events used to compute frequency matrix 808 and time matrix 812, but filtered to emphasize recent events relative to the current build time. In some implementations, the recency matrix of step 814 can be binary (indicating recent versus not recent), while in other implementations, the recency matrix of step 814 can be continuous (indicating a decay-adjusted score).

Constant 816 is provided as an input parameter that can be used to stabilize computations and normalize weights. In the subject disclosure, constant 816 can be configured as a scalar value, such as 1, and can serve as a numerator scaling factor and/or a numerical stability mechanism. Step 818 then computes a pairwise weight between events i and j as a function w (i, j) based on frequency matrix 808, time matrix 812, and the recency matrix computed in step 814, as well as constant 816.

In one representative form illustrated in FIG. 2C, the weight function w (i, j) increases with increasing recency contribution and decreases with increasing co-occurrence frequency and increasing time interval, thereby combining both co-occurrence intensity and temporal spacing into a single relationship value. A non-limiting example weight function w (i,j) is

$$w ( i , j ) = \frac{k}{1 + {F}_{i , j} {T}_{i , j}} + {R}_{i , j} ,$$

where i and j are events, k is constant 816 (e.g., 1), R_{i,j} is the element at row i, column j of recency matrix R calculated at step 814 representing the recency of when the weight was calculated for the weights between the events, F_{i,j} is the element at row i, column j of frequency matrix F 808 representing the frequency of the co-occurrence of the two events, and T_{i,j} is the element at row i, column j of time matrix T 812 representing how close in time the two events occur on average.

The output of step 818 is weighted matrix 820 that stores the computed weight values for the event pairs and can be used as an adjacency representation for subsequent graph construction and community detection.

Weighted matrix 820 is used to create and update an event correlation graph in which events are nodes and the weights derived from weighted matrix 820 are edges or edge weights between nodes. The weighted matrix 820 can support clustering algorithms to identify event communities, and those event communities can be utilized by runtime correlation logic, such as a correlation prediction node in an agentic workflow, to determine whether a present event belongs to a known community, whether additional events are likely, and whether a causal hypothesis can be formed. Event community 802 therefore provides the seed and scope for correlation, frequency matrix 808 and time matrix 812 provide historical relationship measures, recency matrix computed in step 814 provides temporal biasing, constant 816 provides stability and normalization, step 818 fuses the measures into weights, and weighted matrix 820 provides a compact representation suitable for graph analytics and real-time inference.

In some embodiments, the time binning performed in step 804 is not constrained to one-hour bins and instead uses variable-length bins that adapt to diurnal patterns, traffic bursts, maintenance windows, or component-specific event rates. In such embodiments, step 804 can compute co-occurrence counts over bins of differing lengths, and step 806 can aggregate those counts using a weighted aggregation that accounts for bin duration so that longer bins do not dominate frequency matrix 808.

In some embodiments, the time-interval computation in step 810 produces multiple statistics per event pair, such as an average time interval, a median time interval, and a percentile band, and time matrix 812 is implemented as a multi-layer tensor rather than a single matrix. In such embodiments, step 818 can compute the weight w (i,j) using a selected statistic based on context, or can compute multiple weighted matrices 820 specialized for different operational modes (e.g., incident response versus long-term forecasting).

In some embodiments, the recency matrix computed in step 814 uses an exponential decay function, a power-law decay function, or a piecewise decay function that changes slope after a threshold age, thereby controlling how quickly old relationships become negligible. In such embodiments, constant 816 can be dynamically tuned based on the magnitude ranges of frequency matrix 808 and time matrix 812, and step 818 can include clipping, normalization, or rank-based scaling to ensure that weighted matrix 820 is robust to extreme counts or extreme intervals.

The operations of flowchart 800a improve the technical field of computer-implemented operational analytics by producing a correlation representation that simultaneously captures how often events co-occur, how temporally close the events are, and how recently the relationship has been observed. By fusing frequency matrix 808, time matrix 812, and recency matrix computed in step 814 into weighted matrix 820, flowchart 800a reduces reliance on static thresholding or single-metric correlation methods that can miss time-dependent relationships. This reduces spurious correlations caused by high-volume repetitive alerts and enables computing systems to prioritize relationships that are operationally meaningful for diagnosing and predicting degradations.

Weighted matrix 820 further supports practical runtime integration by enabling efficient graph-based lookups and clustering that can be consumed by automated monitoring pipelines. For example, when integrated with an agentic workflow, weighted matrix 820 can be used to accelerate correlation computations for high-impact events and to reduce compute consumption by filtering and ranking candidate related events before deeper analysis. This improves the functioning of computer systems tasked with incident response by reducing redundant processing, improving localization of failure propagation, and enabling earlier detection of correlated event patterns that can otherwise be hidden within large-scale telemetry streams.

FIG. 2C provides an example process used in creating event correlation graph 724, illustrated in FIG. 2B. In one or more embodiments, after generation of the weighted matrix and/or construction of event correlation graph 724, further analysis is performed using one or more clustering techniques to identify event groupings, outliers, and/or latent correlation structures. For example, clustering can include k-means clustering, Density-Based Spatial Clustering of Applications with Noise (DBSCAN), hierarchical clustering, Gaussian Mixture Models (GMM), Spectral Clustering, and/or affinity propagation, applied to the weighted matrix, embeddings derived from event correlation graph 724, and/or feature vectors derived from event-pair statistics. In such embodiments, clustering outputs can be stored as community metadata associated with nodes and/or edges of event correlation graph 724, and can be used by runtime components to support event-to-community assignment, prediction of follow-on events, prioritization of correlated incident signatures, and selection of operational response actions.

FIG. 2D depicts an illustrative embodiment of co-occurrence matrix 800b (i.e., frequency matrix F 808, depicted in FIG. 2C) that can be generated as part of the event community building workflow described in the subject disclosure. In the subject disclosure, co-occurrence matrix 800b serves as a structured, machine-usable representation of how frequently pairs of operational events occur together within a defined observation framework. Co-occurrence matrix 800b can be derived from historical event records collected from a monitored system, such as a 5G core network component environment that includes a UDR and related control-plane services. By structuring event relationships in matrix form, co-occurrence matrix 800b enables downstream computational steps to identify statistically meaningful linkages between events that may otherwise appear as isolated alerts.

In FIG. 2D, co-occurrence matrix 800b is organized as a two-dimensional table in which each row and each column correspond to event identifiers, alert identifiers, or event categories, depicted in the figure as Alert 1, Alert 2, Alert 3, and Alert 4. Co-occurrence matrix 800b can be constructed per event source or per event community scope, shown illustratively as Source A in FIG. 2D, where Source A can represent a component, subcomponent, or telemetry origin (e.g., an application programming interface layer, a caching layer, a data storage layer, or a security layer). Although co-occurrence matrix 800b illustrates an embodiment in which co-occurrences are identified for alerts coming from the same source, it will be apparent to an artisan of ordinary skill that alerts coming from different sources may also be processed for alert co-occurrences. Each cell of co-occurrence matrix 800b stores a count reflecting the number of times that a pair of events occurred together within a predefined time binning or overlap condition, such as within the same one-hour interval, within the same rolling window, or within another configured time-bucket definition used by the system.

The values shown in co-occurrence matrix 800b illustrate that certain event pairs can have high co-occurrence counts. For example, in FIG. 2D, co-occurrence matrix 800b includes values such as 57 for a relationship involving Alert 1 and Alert 2, and 373 for a relationship involving Alert 2 and Alert 3, which indicates that the pairwise co-occurrence between those events has been observed frequently in the historical record. Conversely, co-occurrence matrix 800b also includes zero-valued cells, indicating event pairs that have not been observed to occur together within the configured co-occurrence criteria. These zero-valued cells can reduce computation in subsequent steps by allowing the system to prune candidate correlations or avoid creating graph edges for event pairs that do not exhibit any observed relationship.

In one or more embodiments, values of the co-occurrence matrix 800b are constrained to improve computational efficiency and to improve robustness of downstream correlation analysis. For example, a cap can be applied to a co-occurrence count for an event pair, such that a cell value in the co-occurrence matrix 800b does not exceed a configured maximum even if additional co-occurrences are observed. In such embodiments, capping limits the influence of extremely frequent alert pairs and can reduce the likelihood that a small set of high-volume alerts dominates later weight computation and community detection.

In one or more embodiments, co-occurrence matrix 800b is sparsified using one or more threshold rules. For example, if the number of co-occurrences for an event pair falls below a minimum threshold over an observation window, the corresponding entry can be set to zero (or otherwise treated as absent), thereby reducing storage and reducing processing of weak or potentially incidental relationships. In such embodiments, thresholding reduces the impact of unrelated alerts that occasionally coincide and can help preserve visibility into less frequent but operationally meaningful relationships that might otherwise be obscured by dense background co-occurrence among noisy alerts.

In one or more embodiments, the co-occurrence values stored in co-occurrence matrix 800b are transformed using a logarithmic or other compressive mapping. For example, a logarithmic transform can be applied to co-occurrence counts prior to use in weight computation, thereby enabling meaningful distinctions among co-occurrence values spanning different orders of magnitude while limiting disproportionate influence of very large counts. In such embodiments, the transformed co-occurrence values improve numerical stability and can improve sensitivity to medium-frequency relationships that might otherwise be overshadowed by extremely frequent alert pairs.

Co-occurrence matrix 800b can be computed by scanning time-stamped event records stored in an event repository, incrementing counters whenever a first event and a second event satisfy a co-occurrence condition, and aggregating counts over a selected observation window. The observation window can be a rolling window (e.g., last N days) or a fixed window (e.g., a calendar period) depending on system configuration and operational objectives. In some implementations, the co-occurrence condition can be defined using fixed bins (e.g., hourly bins), while in other implementations the co-occurrence condition can be defined using variable-length bins that adapt to traffic patterns, maintenance windows, or component-specific event rates. Co-occurrence matrix 800b can also be normalized or scaled, such that large event volumes for a noisy event type do not dominate correlation scoring purely due to high raw counts.

Co-occurrence matrix 800b is not necessarily a final correlation artifact; rather, co-occurrence matrix 800b provides a frequency-based relationship measure that can be combined with additional relationship measures, including time interval relationships and recency relationships, to compute an event-to-event weight representation that is suitable for graph construction and community detection. In particular, co-occurrence matrix 800b can correspond to the frequency matrix used in the computation of a weighted matrix, where the weighted matrix is then used to build an event correlation graph for use by an agentic workflow. When integrated into runtime processing, such as a correlation prediction node in a workflow, co-occurrence matrix 800b supports quick identification of event pairs that have historically demonstrated strong coupling, which can be used to generate causal hypotheses, forecast likely subsequent events, or reduce alert fatigue by grouping correlated alerts into higher-level incident patterns.

Co-occurrence matrix 800b further supports the subject disclosure's ability to operate across multiple operational sources. For example, multiple instances of co-occurrence matrix 800b can be built for different sources such as Source A and other sources, where each source can correspond to different monitored layers or network functions. In such implementations, co-occurrence matrix 800b can be used to derive source-specific correlation graphs, or can be aggregated into a multi-source co-occurrence representation that captures cross-source relationships. This enables the correlation structure to reflect both within-component co-occurrence and cross-component propagation, such as where anomalies in a caching layer can co-occur with elevated error codes in an application programming interface layer and latency increases in a data storage layer.

In some embodiments, co-occurrence matrix 800b is computed using weighted co-occurrence counts rather than raw counts, where each co-occurrence increment is scaled based on event severity, event confidence score, or operational impact classification. In such embodiment, a high-severity event can contribute more to co-occurrence matrix 800b than a low-severity event, thereby biasing subsequent correlation steps toward event pairs that are both frequent and operationally important.

In some embodiments, co-occurrence matrix 800b is computed using probabilistic co-occurrence metrics, such as conditional probabilities or mutual information, instead of absolute counts. In such embodiments, co-occurrence matrix 800b can encode the likelihood that Alert j occurs given Alert i, which can improve prediction for asymmetric relationships and can reduce spurious edges for high-volume alerts that co-occur with many other alerts merely due to traffic volume.

In some embodiments, co-occurrence matrix 800b is constructed as a sparse matrix or compressed representation, where only non-zero relationships are stored and indexed. Such embodiments can improve memory and compute efficiency when the number of event types is large and the majority of event pairs do not co-occur. In such embodiments, co-occurrence matrix 800b can be implemented using adjacency lists, hash maps, or other sparse data structures while still representing the same conceptual frequency relationships.

Producing co-occurrence matrix 800b improves the functioning of computer-implemented monitoring and incident analytics systems by transforming high-volume event streams into a compact relational representation that can be processed efficiently. Representing pairwise event frequency relationships in co-occurrence matrix 800b enables rapid identification of historically coupled alerts without requiring repeated scans over raw logs for each runtime incident. This reduces redundant computation and decreases latency in correlation analysis, which in turn improves responsiveness of automated operational workflows.

Co-occurrence matrix 800b further provides a practical data structure that supports downstream fusion with time-interval and recency measures to produce robust correlation weights suitable for graph-based community detection. This improves reliability of correlation in environments where static thresholding and ad hoc rule sets can generate excessive noise. By enabling a more structured and data-driven correlation representation, the subject disclosure reduces alert fatigue and improves the quality of incident grouping, which improves the technical field of automated network operations and supports stable performance of core data services.

FIG. 2E depicts an illustrative embodiment of a time interval matrix 800c (i.e., time matrix T 812, depicted in FIG. 2C) that can be generated and maintained as part of the event community building workflow of the subject disclosure. Time interval matrix 800c serves as a structured representation of temporal spacing relationships between pairs of operational events. While a co-occurrence representation captures whether event pairs appear together within a defined bin or window, time interval matrix 800c captures how far apart in time the paired events occur when the events are related, thereby providing a temporal dynamic that can distinguish near-simultaneous co-failures from delayed propagation patterns. Time interval matrix 800c can be computed using time-stamped events originating from monitored components of a mobile network core, such as a 5G control-plane environment that includes a UDR and other service-based network functions.

In FIG. 2E, time interval matrix 800c is organized as a two-dimensional table in which each row and each column correspond to event identifiers, alert identifiers, or event categories, depicted illustratively as Alert 1, Alert 2, Alert 3, and Alert 4. Time interval matrix 800c can be constructed per event source or per correlation scope, shown illustratively as Source A in FIG. 2E, where Source A can represent a component, subcomponent, service endpoint, or telemetry origin such as an application programming interface layer, caching layer, data storage layer, or security layer. Although only a single source of alerts is depicted in FIG. 2E, it is readily apparent to an artisan of ordinary skill that multiple sources of alerts may be included in some embodiments of a time interval matrix. Each cell of time interval matrix 800c stores a representative time interval for a pair of alerts, where the representative time interval can reflect a statistic computed across historical observations in which the alert pair occurs within a configured temporal window. In some implementations, the representative time interval stored in a cell is an average time difference, while in other implementations the representative time interval stored in the cell is a median, trimmed mean, percentile value, or other robust statistic that reduces sensitivity to outliers.

The example values shown in time interval matrix 800c illustrate that different event pairs can have different characteristic latencies between occurrences. For example, in FIG. 2E, one cell indicates a time interval of 3 minutes for an alert-pair relationship, while another cell indicates a time interval of 25 minutes for a different alert-pair relationship. A shorter representative time interval in time interval matrix 800c can indicate that the paired events tend to occur close together in time, which can be characteristic of a common-cause fault or tightly coupled dependency. In contrast, a longer representative time interval in time interval matrix 800c can indicate delayed propagation, staged failures, or cascading effects (e.g., a storage saturation event followed by an API timeout event), which can be relevant to forecasting and proactive mitigation.

Time interval matrix 800c can be computed by scanning an event repository of time-stamped event records and, for each event pair, calculating time differences between event occurrences that satisfy a pairing rule. In one implementation, the system identifies occurrences of a first alert and searches within a forward-looking or symmetric temporal window to locate the corresponding occurrence of a second alert, and then computes a delta time between the occurrences. The temporal window used for identifying candidate pairs can be configured as a fixed duration (e.g., three hours) or can be configured dynamically based on the operational characteristics of the monitored system. After computing multiple delta times for a given alert pair across a selected observation window, the system aggregates those delta times to compute the representative time interval stored in the corresponding cell of the time interval matrix 800c.

Time interval matrix 800c is used in combination with a co-occurrence representation and a recency representation to compute event-to-event weights for use in graph construction and community detection. For example, where a co-occurrence matrix provides a frequency measure of how often two alerts appear together, time interval matrix 800c provides a temporal separation measure that differentiates rapid co-occurrence from delayed sequencing. This combined use enables the system to represent both “strength of relationship” and “timing of relationship” in a compact form that supports downstream correlation analytics. In runtime integration, a correlation prediction node can use time interval values derived from time interval matrix 800c to infer when a second alert is likely to follow a first alert, thereby enabling the generation of predictive hypotheses and the selection of remediation actions before downstream impacts materialize.

Time interval matrix 800c can be constructed and maintained as a sparse or partially populated representation, where time interval statistics are stored primarily for event pairs that satisfy a minimum co-occurrence threshold or that exhibit operational significance. In such implementations, event pairs with insufficient historical observations can be left blank, set to a sentinel value, or represented as zero-valued entries, thereby conserving memory and avoiding overfitting to rare, unrepresentative pairings. Additionally, time interval matrix 800c can be updated periodically using a sliding historical window so that time interval characteristics adapt to evolving system behavior, software releases, and configuration changes in cloud-native network deployments.

In some embodiments, time interval matrix 800c stores multiple representative time interval statistics per alert pair, such as an average time interval, a median time interval, and a high-percentile time interval (e.g., a 90th percentile), thereby enabling downstream logic to select a statistic based on context. In such embodiments, time interval matrix 800c can be implemented as multiple matrices or as a multi-dimensional tensor, and runtime correlation logic can select a conservative or aggressive prediction horizon depending on severity and operational policy.

In some embodiments, time interval matrix 800c stores directional time intervals, separating a first-to-second alert delay from a second-to-first alert delay, thereby capturing asymmetric dependencies. In such embodiments, the system can treat time interval matrix 800c as representing directed edges in a graph, enabling the correlation representation to reflect causal directionality more explicitly, which can improve forecasting of cascading failures.

In some embodiments, the representative time interval stored in time interval matrix 800c is computed using robust estimation methods that discount or exclude maintenance-window events, known test events, or anomaly artifacts. For example, the system can filter event records by tag or by confidence score before computing the deltas used in time interval matrix 800c, thereby improving the reliability of time interval estimates used for prediction.

Producing time interval matrix 800c improves the technical field of computer-implemented monitoring and correlation analytics by providing a time-aware correlation artifact that captures how operational events are temporally spaced, not merely whether they co-occur. Leveraging time interval matrix 800c as an input to correlation weights and community detection enables computing systems to distinguish between near-simultaneous events that may share a common cause and delayed sequences that may indicate cascading failures. This supports improved root-cause localization and improves the quality of automated incident grouping, thereby reducing redundant processing and reducing alert fatigue in high-volume monitoring environments.

Further, time interval matrix 800c provides practical runtime value by enabling prediction of follow-on alerts and by supporting earlier remediation. When integrated into an agentic workflow that performs automated correlation and troubleshooting, time interval matrix 800c allows a correlation prediction node to infer that a second event is likely to occur within a predicted time horizon after a first event. This can improve the functioning of computer systems that manage service availability by enabling proactive execution of corrective actions, reducing mean time to mitigation, and reducing the computational overhead of repeatedly scanning raw telemetry streams during incident response.

FIG. 2F depicts an illustrative embodiment 800d of a weighted matrix (i.e., weighted matrix 820, depicted in FIG. 2C) that can be generated and used as part of the event community builder. A weighted matrix serves as a compact representation of pairwise relationships among events, where each relationship weight is derived from at least co-occurrence frequency, time-interval spacing, and recency characteristics computed from historical event data. The weighted matrix in FIG. 2F is shown as a tabular summary in which event communities are grouped and characterized to enable downstream operational interpretation, such as identifying groups that reflect tightly coupled co-occurring events, groups that support forecasting, and groups that are deprioritized due to weak coupling or limited operational scope.

In FIG. 2F, the weighted matrix categorization artifact 800d includes a community identifier field (e.g., Community 1, Community 2, Community 3, Community 4), a Count field, an Average Time field, and a Categorization field. The Count field in FIG. 2F can correspond to a relative magnitude of a frequency-based relationship measure derived from a co-occurrence structure, where a higher Count indicates that events within the community have historically occurred together more often. The Average Time field in FIG. 2F can correspond to a relative magnitude of a time-interval relationship measure derived from a time interval matrix, where Less indicates that events within the community tend to occur close together in time and More indicates that events within the community tend to be temporally separated by longer delays. The Categorization field in FIG. 2F provides representative operational interpretations of the combined Count and Average Time characteristics, enabling the subject disclosure to map community structures to actionable monitoring and remediation behaviors.

A first example depicted in FIG. 2F is Community 1, which is characterized by High Count and Less Average Time. Community 1 can represent a group of frequently co-occurring events that tend to occur near-simultaneously, which can be indicative of tightly coupled dependencies, common-cause faults, or correlated failure modes. Such a community, as represented in FIG. 2F, can be categorized as “frequently co-occurring events at same time,” which can be used by downstream runtime logic to suppress redundant alerts and to treat multiple raw events as a single compound incident signature. In this way, Community 1 supports reduction of alert fatigue while preserving an accurate representation of the underlying operational incident.

A second example depicted in FIG. 2F is Community 2, which is characterized by High Count and More Average Time. Community 2 can represent event pairs or event clusters that occur together with high regularity but with a consistent temporal lag between them. Such a community can be categorized in FIG. 2F as “events that can be predicted,” because the persistent lag enables forecasting of follow-on events once an initiating event is observed. In runtime integration, a correlation prediction node can use Community 2 characteristics to anticipate downstream effects and to trigger earlier evidence gathering or remediation actions before a predicted follow-on event produces service impact. Community 2 therefore supports proactive operational handling rather than purely reactive alert response.

A third example depicted in FIG. 2F is Community 3, which is characterized by Low Count and More Average Time. Community 3 can represent a group of weakly coupled events that co-occur infrequently and with relatively large temporal separation. Such a community can be categorized as “lower priority,” because the sparse relationship provides weaker evidence of operational coupling and may be more likely to reflect incidental co-occurrence or non-actionable background conditions. In some implementations, Community 3 can be retained for long-term learning or offline analysis while being deprioritized in runtime correlation to conserve computational resources and reduce false-positive correlation.

A fourth example depicted in FIG. 2F is Community 4, which is characterized by Low Count and Less Average Time. Community 4 can represent infrequent co-occurrences that happen near in time but do not have sufficient historical repetition to justify strong coupling assumptions. Such a community can be categorized as “low scope of optimization,” indicating that the community may not yet be suitable for aggressive automation or broad operational policy adjustments. In some implementations, Community 4 can be monitored for growth, and, when subsequent observations increase the Count for Community 4, the community can migrate toward Community 1 or Community 2 behavior classes as additional data becomes available.

Weighted matrix 800d is not necessarily a final output delivered to an operator; rather, weighted matrix categorization artifact 800d can be used as an intermediate representation that guides runtime decisions by agentic components. For example, a triage agent can use the community classification represented in weighted matrix 800d to decide whether an observed event should be escalated, monitored, or ignored, and a correlation prediction node can use the community classification represented in weighted matrix categorization artifact 800d to determine whether prediction logic should be invoked. Similarly, a final summary agent can use the community classification represented in weighted matrix categorization artifact 800d to generate grouped recommendations and to select appropriate operational runbooks. In this manner, FIG. 2F provides an interpretable mapping between quantitative correlation signals and operational actions.

In some embodiments, the categorization boundaries used in the weighted matrix categorization artifact 800d are dynamically tuned based on component type, network slice, tenant, or time-of-day patterns. In such embodiments, High Count and Low Count thresholds, and Less Average Time and More Average Time thresholds, are not fixed values and instead are computed from percentiles or adaptive baselines, allowing the community categories to remain stable despite changes in overall event volume.

In some embodiments, weighted matrix 800d includes additional fields beyond Count and Average Time, such as a recency score summary, an operational impact score, or a confidence interval for the time interval statistic. In such embodiments, the categorization field in weighted matrix 800d can be derived from multi-factor scoring rather than from a two-dimensional High/Low and Less/More scheme, enabling more granular action selection policies.

In some embodiments, weighted matrix 800d is implemented as a machine-readable policy table or as metadata attached to community identifiers in an event correlation graph, enabling runtime agents to query the classification directly through graph lookups. In such embodiments, the table-like form shown in FIG. 2F is a presentation of the underlying metadata, and the runtime systems consume the metadata via application programming interfaces or database queries.

In one or more embodiments, although qualitative labels are illustrated in FIG. 2F (e.g., High or Low Count and More or Less Average Time), the categorization reflected by weighted matrix 800d can be implemented using numerical values, thereby enabling more granular definitions for communities, similar counts, and similar time-interval characteristics. For example, numeric thresholds can be established using quartiles, deciles, or other quantiles of observed count values and/or observed time-interval values, such that communities are defined based on whether a given relationship metric falls within a selected quantile band. In such embodiments, the categorization boundaries are derived from distributional analysis of the underlying co-occurrence and time-interval statistics rather than from fixed qualitative bins.

In one or more embodiments, communities, groupings of count values, and/or groupings of time-interval values used for community interpretation are derived using clustering and segmentation analysis applied to feature vectors associated with event pairs and/or event communities. For example, clustering can include k-means clustering, DBSCAN, hierarchical clustering, GMM, Spectral Clustering, and/or affinity propagation, applied to count measures, time-interval measures, recency measures, or combinations thereof. In such embodiments, the resulting cluster identifiers or cluster memberships are stored as machine-readable community metadata and are used by runtime components to assign events to communities and to select monitoring, prediction, and remediation behaviors.

In one or more embodiments, time-interval characterization used in community interpretation is based on statistical values other than, or in addition to, averages. For example, a median time interval, one or more percentile values, a trimmed mean, or confidence bounds can be computed for a given event-pair relationship and used to determine whether the relationship exhibits near-simultaneous behavior or delayed propagation behavior. In such embodiments, use of robust statistics improves stability of community definitions by reducing sensitivity to outliers and enabling more reliable selection of prediction horizons and remediation timing.

Producing weighted matrix 800d improves computer-implemented monitoring and remediation by providing a structured and computable mapping from correlation features into operationally meaningful community types. By representing relationship categories such as those depicted in FIG. 2F in weighted matrix 800d, computing systems can more efficiently decide which correlations warrant prediction, escalation, or suppression, thereby reducing unnecessary computation and reducing redundant alarm processing. This improves responsiveness of automated incident workflows and reduces operator alert fatigue by enabling the system to treat correlated groups as cohesive incident patterns rather than as unrelated individual alerts.

Further, the use weighted matrix categorization artifact 800d improves the technical field of proactive network operations by enabling prediction-aware remediation. Communities characterized by High Count and More Average Time, as represented in FIG. 2F, can be used to forecast follow-on events and initiate corrective actions earlier, reducing mean time to mitigation and reducing the likelihood of cascading failures. This provides practical deployment value in cloud-native core environments where transient degradations and dependency chains can otherwise generate ambiguous and noisy telemetry.

FIG. 2G depicts an update workflow 800e for maintaining and refreshing correlation weights used by the subject disclosure, particularly by incorporating recency changes into a previously computed correlation structure. Update workflow 800e is used after an initial event-community build has produced a baseline relationship representation, such as a weighted matrix, and update workflow 800e enables the correlation representation to remain aligned with evolving system behavior over time. Update workflow 800e thereby supports continuous learning and adaptation in operational environments, such as a 5G core network monitoring setting, where event relationships can drift due to software releases, configuration changes, scaling behavior, traffic shifts, or changing failure modes.

In FIG. 2G, weighted matrix 850 is shown as an input correlation artifact. Weighted matrix 850 can correspond to an adjacency-like representation of pairwise relationships among events, where events are nodes and weights represent coupling strength. In the subject disclosure, weighted matrix 850 can be generated from historical event data using multiple factors, including co-occurrence frequency, time interval relationships, and recency. Weighted matrix 850 therefore serves as a compact computational object that downstream processes can use for clustering, event-community identification, and runtime correlation inference.

Also shown in FIG. 2G are multiple component matrices that provide the constituent factors for weighted matrix 850. Co-occurrence matrix F 852 represents how frequently a given pair of events occurs together within a defined observation window and co-occurrence rule set. Time interval matrix T 854 represents a characteristic temporal spacing (e.g., an average or other statistic) between event occurrences for event pairs that exhibit temporal association. Recency matrix R 856 represents a measure that biases event-pair relationships toward more recent observations, such as by indicating whether an event-pair relationship has been observed within a recent horizon or by encoding a continuous decay-adjusted score. Co-occurrence matrix F 852, time interval matrix T 854, and recency matrix R 856 are maintained as structured artifacts so that the correlation model can be interpreted, recomputed, or selectively updated as new event data arrives.

FIG. 2G further depicts a delta recency matrix 858 that represents an incremental or differential change in recency contributions relative to a prior state. Delta recency matrix 858 can be computed based on newly observed events within an update window (e.g., the last day, the last week, or another configured interval) and can reflect which event-pair relationships have become more recent, less recent, or newly observed. For example, if a specific event-pair relationship was previously stale but has reappeared in current operations, delta recency matrix 858 can increase the recency contribution for that relationship. Conversely, if previously common relationships have not been observed in the recent horizon, delta recency matrix 858 can reduce the recency contribution for those relationships according to a decay policy.

Using delta recency matrix 858 and calculations 862 based on F, T, and R produces updated weighted matrix 860. Updated weighted matrix 860 represents a refreshed correlation artifact that incorporates recency changes while preserving, reusing, or partially reusing previously computed relationship structure. In some implementations, updated weighted matrix 860 is obtained by recomputing weights for event pairs affected by delta recency matrix 858 while leaving other weights unchanged. In other implementations, updated weighted matrix 860 is obtained by applying a blending rule that combines a prior weighted matrix with an update contribution derived from delta recency matrix 858, optionally normalized or clipped to maintain stability. This update mechanism can reduce compute cost compared to full recomputation while still allowing the subject disclosure to adapt to current operational reality.

In one or more embodiments, the recency matrix 856 is initialized as a binary matrix during an initial recency period, such as a first week of operation or a first week of observation after a model refresh. In such embodiments, a value of 1 is assigned in recency matrix 856 for a pair of events that co-occur within the initial recency period (or within a defined co-occurrence criterion for that period), and a value of 0 is assigned in recency matrix 856 for a pair of events that does not co-occur within the initial recency period. The resulting binary form provides an initial recency bias that favors event-pair relationships that have been observed recently while excluding unobserved relationships from recency contribution. Although values of 1 and 0 are disclosed herein, other values may be chosen, for example to enable integer rather than floating point operations.

In one or more embodiments, after the initial recency period, recency values in the recency matrix 856 are updated using a decay rule that reduces non-zero values over time for event pairs that have not re-occurred recently. For example, during a subsequent update period, one or more non-zero entries of recency matrix 856 can be reduced by subtracting a constant value, multiplying by a percentage factor, or applying another decay function, thereby diminishing the recency contribution for event pairs that were observed previously but have not been observed again within a more recent horizon. In such embodiments, recency values for event pairs that do co-occur during the subsequent update period can be maintained, boosted, or reset to a higher value according to policy, such that persistent relationships remain emphasized while stale relationships are progressively down-weighted. In some embodiments, a minimum non-zero threshold value may be employed such that reducing a recencly value is set to zero if it would otherwise be reduced to a non-zero value below the threshold value.

In one or more embodiments, the decay-based update of recency matrix 856 improves quality of updated weighted matrix 860 by minimizing the impact of co-occurrences that were coincidental or that are no longer indicative of operational coupling. For example, as infrastructure, configuration, or software changes occur, certain event-pair relationships can cease to be relevant; reducing the recency contribution for such stale relationships reduces spurious correlation edges and improves the stability of downstream clustering, prediction, and alert-grouping behavior derived from updated weighted matrix 860.

Update workflow 800e can be executed as a scheduled maintenance task, as a rolling update process, or as an event-triggered refresh routine when certain drift conditions are detected (e.g., when a correlation prediction node begins producing low-confidence results or when a monitoring system detects that baseline distributions have shifted). Updated weighted matrix 860 can then be used to rebuild or update a corresponding event correlation graph, to refresh community detection outputs, and to improve the accuracy of runtime correlation and prediction. In practical use, updated weighted matrix 860 supports the agentic workflow by providing more current correlation context for high-impact event handling, such that remediation selection and alert grouping are grounded in relationships that reflect recent and relevant system dynamics.

In some embodiments, delta recency matrix 858 is computed using a binary rule in which an event-pair relationship is set to a first value when observed within a short-term horizon and set to a second value when not observed within the short-term horizon. In such embodiments, updated weighted matrix 860 is produced by selectively boosting weights for recently observed relationships and leaving other weights derived from weighted matrix 850 unchanged, thereby simplifying update computation while still enabling recency-aware adaptation.

In some embodiments, delta recency matrix 858 is computed using a continuous decay function such as exponential decay, power-law decay, or a piecewise decay model that changes slope after a threshold age. In such embodiments, updated weighted matrix 860 is generated by applying a smoothing factor that reduces oscillations in weights and prevents rapid swings due to short-lived bursts of events. This can be beneficial in cloud-native systems where ephemeral scaling events can temporarily change event patterns without reflecting persistent operational coupling.

In some embodiments, update workflow 800e is extended to incorporate delta updates for co-occurrence matrix 852 and time interval matrix 854 in addition to delta recency matrix 858. In such embodiments, updated weighted matrix 860 is computed based on incremental updates to co-occurrence matrix 852, incremental updates to time interval matrix 854, and incremental updates to recency matrix 856, enabling fuller adaptation to drift while still avoiding full recomputation of the entire weighted matrix 850.

Producing updated weighted matrix 860 improves the functioning of computer-implemented monitoring and correlation systems by providing an efficient update mechanism that maintains correlation accuracy as operational conditions evolve. Generating updated weighted matrix 860 from weighted matrix 850 and delta recency matrix 858 reduces the computational overhead associated with repeatedly scanning large historical event repositories and recomputing full correlation structures from scratch. This efficiency improvement enables more frequent updates, which can improve timeliness of correlation and prediction in large-scale deployments with high event volume.

Further, update workflow 800e improves the technical field of proactive network operations by enabling recency-aware correlation that remains aligned with current system behavior. Correlation structures that are not updated can become stale and can drive incorrect grouping, incorrect prediction horizons, or incorrect prioritization. This is addressed by integrating a recency change mechanism via delta recency matrix 858 and by producing updated weighted matrix 860 used by downstream clustering and runtime inference. This improves practical integration of correlation analytics into automated incident workflows, helping reduce alert fatigue and improving the quality of root-cause hypotheses and remediation actions.

In one or more embodiments, one or more agents of workflow 700 implement operational guardrails to improve reliability of automated decisioning and to reduce the likelihood of incorrect or unsafe corrective actions. For example, prior to initiating an operational action, an agent can compute one or more confidence values based on corroborating evidence obtained from multiple sources (e.g., event datastore 720, event correlation graph 724, componentwise periodic error datastore 726, and/or external telemetry sources accessed by the event tracker 712) and can compare the confidence values to one or more policy thresholds. In such embodiments, when confidence is below a threshold, the agent can degrade gracefully by requesting additional evidence, generating an operator notification, creating a monitoring record without executing a corrective action, or routing the task for human approval, while when confidence satisfies the threshold the agent can proceed with execution of an automated runbook or other corrective workflow.

In one or more embodiments, guardrails include action eligibility rules that limit what operations can be executed automatically and under what conditions. For example, playbook 744 can be associated with allowlists and denylists of runbooks, parameter constraints, rate limits, and/or cooldown timers, such that automated actions are constrained to approved remediation operations and are not repeatedly invoked in a manner that can destabilize the monitored system. In such embodiments, actions can be staged, including performing a non-destructive validation step (e.g., read-only verification, configuration inspection, or dependency reachability check) prior to executing a state-changing step, and can further include rollback operations or compensating actions that are invoked when a post-action validation indicates that a remedial operation did not improve a measured health indicator. In one or more embodiments, guardrails further include provenance checks and tamper-evidence checks against incident-level records, such that retrieved prior handling artifacts are verified for integrity prior to being used as context for action selection.

In one or more embodiments, workflow 700 adaptively updates alerting criteria used for categorization and routing decisions based on observed operational baselines and prior outcomes. For example, one or more agents can compute or update baseline ranges for one or more metrics (e.g., error rate, latency, saturation, retry rate, or timeout rate) for a component or subcomponent, and can adjust one or more thresholds used to classify events as high-impact path 790 candidates or low-impact path 792 candidates. In such embodiments, baseline and threshold updates can be computed per component, per deployment region, per tenant, and/or per network slice, and can be updated using rolling windows or drift detection so that routine fluctuations do not repeatedly trigger escalation while true anomalies remain detectable. In one or more embodiments, threshold updates are conditioned on remediation outcomes recorded in incident-level records so that thresholds are not adjusted in a manner that would suppress alerts correlated with service-impacting incidents.

One or more embodiments can include a reinforcement mechanism that uses prior successful incident handling to accelerate and improve subsequent troubleshooting. For example, final summary agent 714 can store, in blockchain 740 or another datastore, structured incident-level records that include: a normalized incident signature; a set of correlated events and community identifiers; a selected remediation action sequence; pre-action and post-action health indicators; and an outcome status. In such embodiments, triage agent 706 and/or correlation prediction node 708 can retrieve one or more prior incident-level records based on similarity between a current incident signature and a stored signature, rank candidate prior mitigations according to outcome quality and recency, and use the ranked mitigations as decision support for selecting an action or selecting an evidence-gathering plan. In one or more embodiments, the reinforcement mechanism enables quicker convergence on corrective actions for recurring failure modes while preserving visibility into distinct coincident failures that do not match previously recorded incident signatures.

In one or more embodiments, workflow 700 manages computational resource consumption associated with AI model execution, including managing costs associated with generating and processing natural-language outputs. For example, one or more agents of workflow 700 can enforce a computational budget, a token budget, and/or a latency budget per event, per incident signature, per component, per slice, and/or per time interval, and can select among multiple model configurations based on the budget and the priority of an event. In such embodiments, lower-impact events can be processed using smaller or less expensive models and/or reduced-context prompts, while higher-impact events can be processed using larger models and/or richer context. In one or more embodiments, workflow 700 reduces context payload sizes by summarizing, compressing, or chunking retrieved artifacts, by caching intermediate summaries, by reusing previously generated embeddings or incident signatures, and/or by retrieving only incremental deltas from external sources when subsequent events occur within a short time window, thereby reducing repetitive tool calls and reducing repeated ingestion of large event payloads.

In one or more embodiments, final summary agent 714 and/or another agent of workflow 700 performs change correlation using information obtained from code repository 742 and/or other configuration sources to determine whether a code change, configuration change, deployment change, or dependency change is temporally associated with an observed incident signature. For example, final summary agent 714 can query code repository 742 for commits, diffs, deployment manifests, and/or configuration files that occurred within a time window around a detected event onset time, and can rank candidate changes based on relevance to an implicated component, interface, or event community. In such embodiments, workflow 700 can incorporate change correlation as evidence in selecting an operational action, including selecting a rollback runbook, selecting a configuration reversion runbook, escalating to a human operator for review of a suspected change, or annotating an after-action record with a suspected change identifier for future reuse and reinforcement.

In one or more embodiments, construction of correlation structures is partitioned into an offline phase and an online phase. For example, an offline or batch process can periodically compute or refresh event correlation graph 724, including weighted matrices and community metadata, based on a historical observation window (e.g., a last N-day rolling window) and store the results for later use. In such embodiments, an online or runtime component (e.g., the correlation prediction node 708) primarily performs lookups, similarity evaluations, and prediction inference using precomputed event correlation graph 724 rather than recomputing the full correlation structure during a live incident, thereby reducing runtime computational load and reducing latency in high-impact event handling. In one or more embodiments, the offline refresh is scheduled (e.g., nightly, weekly, or during low-load periods) and is also triggered by detected drift conditions, such that refreshed correlation structures reflect evolving operational patterns while maintaining stable and bounded runtime performance.

In one or more embodiments, the time interval relationships used for correlation include directionality and signed time deltas, such that a first event can be characterized as tending to precede a second event by a positive time interval or tending to follow the second event by a negative time interval. In such embodiments, correlation prediction node 708 can use directional time interval relationships to estimate not only that a follow-on event is likely, but also a predicted time horizon for when the follow-on event is likely to occur, thereby enabling proactive evidence gathering and earlier remediation selection. In one or more embodiments, average time interval values are used as a representative statistic for such directional prediction, while other embodiments use one or more additional statistics to bound or qualify the prediction horizon.

In one or more embodiments, incident-level records stored in blockchain 740 or another datastore include a reasoning trace and action trace that represents how a set of events was triaged, correlated, and mitigated, and such traces are stored in a manner that preserves operational utility while limiting exposure of sensitive content. For example, workflow 700 can store a structured record containing an incident signature, implicated components, community identifiers, selected actions, and outcomes, while storing a full reasoning trace separately, storing only a redacted reasoning trace, and/or storing a cryptographic digest or pointer to a secured object that contains additional reasoning detail. In such embodiments, access control policies can restrict retrieval of detailed reasoning traces to authorized entities, while still enabling triage agent 706 and/or correlation prediction node 708 to reuse the stored records for reinforcement and decision support.

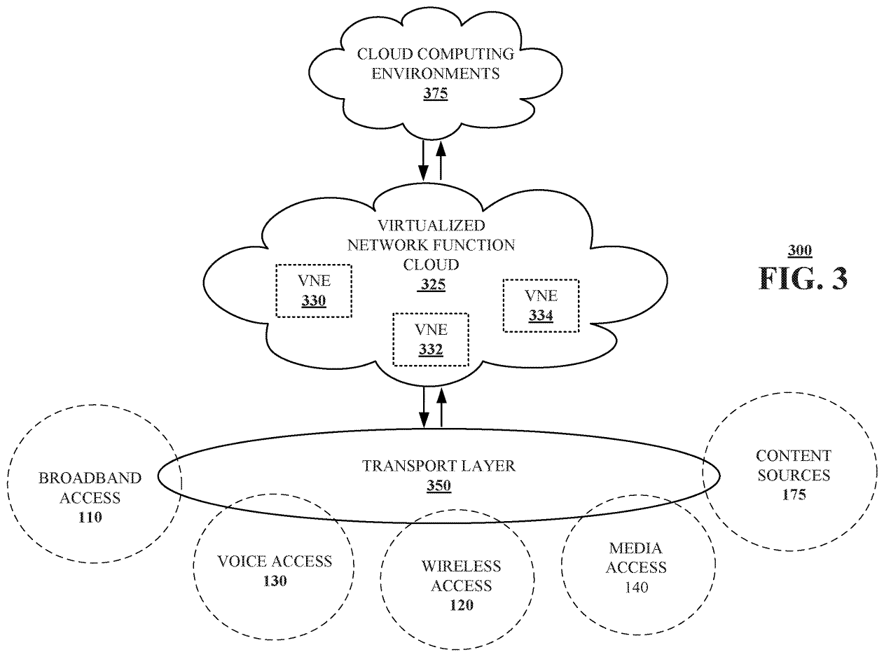

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, analyzed events may be produced by virtualized components of virtualized network 300, or by devices interacting with virtualize communication network 300. Moreover, the analytical systems and processes disclosed herein may be deployed, in whole or in part, in virtualized communication network 300.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

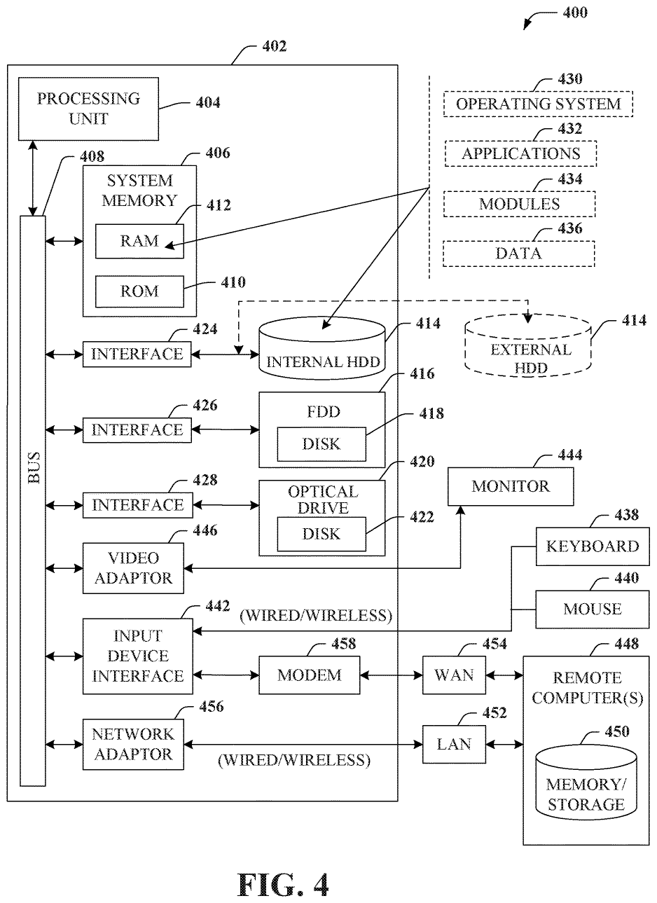

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. Computing environment 400 can facilitate in whole or in part one or more of the agentic AI models disclosed herein. Computing environment 400 can also facilitate non-agentic AI model technologies, such as datastores, blockchains, and protocol execution.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

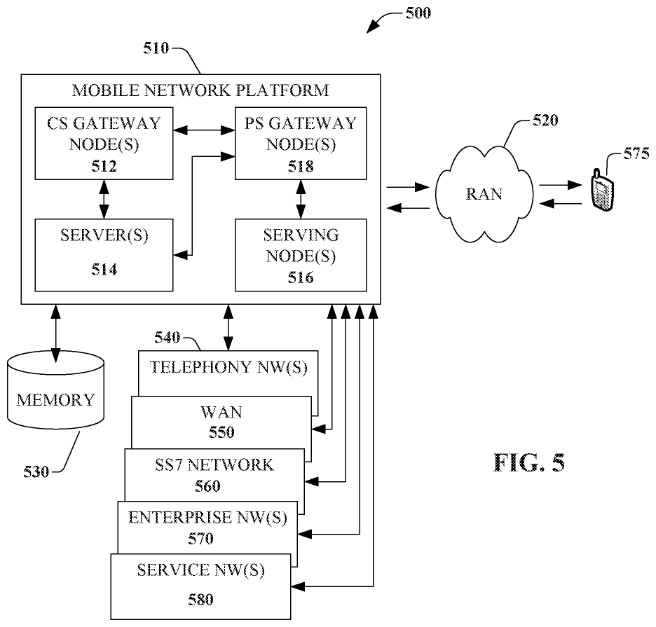

Turning now to FIG. 5, an embodiment 500 of a mobile network platform 510 is shown that is an example of network elements 150, 152, 154, 156, and/or VNEs 330, 332, 334, etc. For example, platform 510 can originate analyzed events and/or host systems for analyzing such events. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

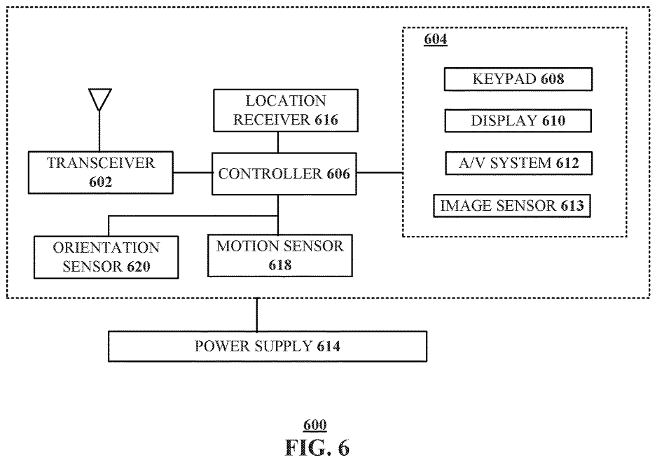

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part event creation or communications used for event resolution.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ AI in other aspects to facilitate automating one or more features described herein not expressly detailed above. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
retrieving a plurality of instances of events from a community of events;
determining, for a first event of the plurality of instances of events and for a second event of the plurality of instances of events, a frequency in which both an instance of the first event and an instance of the second event occur within a window of time, thereby producing a frequency determination;
determining, for the first event and for the second event, a metric characterizing how temporally close together instances of the first event and instances of the second event occur, thereby producing a time determination;
determining, for the first event and for the second event, a metric characterizing a recency of the frequency determination and the time determination, thereby producing a recency determination;
determining, based on the frequency determination, the time determination, and the recency determination, a metric characterizing the correlation of the first event and the second event, thereby producing a correlation determination;
receiving an alert representing another instance of the first event;
based on the correlation determination, predicting the likelihood of a second alert being received representing another instance of the second event, thereby producing a correlation likelihood determination; and
initiating corrective action based on the correlation likelihood determination.

2. The device of claim 1, wherein the community of events includes events that occur in a mobility network.

3. The device of claim 1, wherein one or more of the operations of determining the frequency determination, the time determination, the recency determination, or the likelihood determination are performed by an Artificial Intelligence (AI) model.

4. The device of claim 1, wherein the operations further comprise:
receiving the second alert; and
determining that the correlation likelihood determination indicates a low correlation;
wherein, based on the determination that the correlation likelihood determination indicates a low correlation, the initiating the corrective action includes initiating a first correction action directed to resolving the first alert and initiating a second corrective action directed to resolving the second alert.

5. The device of claim 1, wherein the operations further comprise:
receiving the second alert; and
determining that the correlation likelihood determination indicates a high correlation;
wherein, based on the determination that the correlation likelihood determination indicates a high correlation, the initiating the corrective action includes initiating a single correction action directed to resolving both the first and the second alerts.

6. The device of claim 1, wherein the time determination is calculated as the average time between instances of the first event and instances of the second event occurring within a time interval.

7. The device of claim 1, wherein the recency determination is set to a predefined value when the frequency determination and recency determinations are made, and wherein the recency determination is reduced by a first reduction value after a first time interval following the initial setting of the recency determination.

8. The device of claim 7, wherein the recency determination is reduced by a second reduction value after a second time interval following the first time interval, wherein the second reduction value is different than the first reduction value.

9. The device of claim 1, wherein the correlation likelihood determination is determined by calculating a weight function w(i,j) defined as
$$w ( i , j ) = \frac{k}{1 + {F}_{i , j} {T}_{i , j}} + {R}_{i , j} ,$$
where i is the first event and j is the second event, k is constant, R_{i,j} is the recency determination, F_{i,j} is the frequency determination, and T_{i,j} is the time determination.

10. A non-transitory machine-readable medium, comprising executable instructions that, when executed by a processing system including a processor, facilitate performance of operations, the operations comprising:
receiving, from a first Artificial Intelligence (AI) model, a first instance of a first event;
retrieving, from a datastore, first data comprising instances of a plurality of events and their respective resolutions;
determining, based on the first data, that the first instance is a high-impact event, thereby producing a high-impact event determination; and
sending, based on the high-impact event determination, the first instance to a second AI model that performs a correlation analysis of the first event with the plurality of events using the first instance.

11. The non-transitory machine-readable medium of claim 10, wherein the operations further comprise:
receiving, from the first AI model, a second instance of a second event;
determining, based on the first data, that the second instance is a low-impact event, thereby producing a low-impact event determination; and
sending, based on the low-impact event determination, the second instance to a third AI model that produces a summary of the second instance.

12. The non-transitory machine-readable medium of claim 10, wherein the datastore stores immutable records.

13. The non-transitory machine-readable medium of claim 12, wherein the datastore is a blockchain.

14. The non-transitory machine-readable medium of claim 12, wherein the datastore comprises code repository records, playbook records, and customer chat channel records.

15. The non-transitory machine-readable medium of claim 10, wherein the determining the high-impact event determination comprises determining one or more of determining that the first event occurs infrequently, predicting the first instance is likely to trigger more event instances, predicting that a non-routine corrective response will be required to resolve the first instance, or a combination thereof.

16. The non-transitory machine-readable medium of claim 11, wherein the determining the low-impact event determination comprises determining one or more of determining that the second event occurs frequently, predicting the second instance is unlikely to trigger more event instances, predicting that a routine corrective response will be required to resolve the second instance, or a combination thereof.

17. A method, performed using an Artificial Intelligence (AI) model, comprising:
receiving, by the AI model, a correlation prediction that predicts a likelihood that, as a result of a first instance of a first event arising, a second instance of a second event will occur within a window of time;
retrieving, by the AI model, error information from a datastore;
receiving, by the AI model, additional event information;
sending the correlation prediction, the error information, and the additional event information to a second AI model for summarization and storage into a second datastore.

18. The method of claim 17, wherein the correlation prediction is received from a third AI model that produced the correlation prediction for the first event and the second event based on the frequency with which instances of the first event and the second event occur within the within the window of time, a statistical indicator of how temporally close together instances of the first event and the second event occur together, and an indicator of how recently values used to make correlation prediction was determined.

19. The method of claim 17, wherein the additional event information comprises one or more of data obtained through Application Programming Interface (API) monitoring, information obtained from a caching layer, information obtained from a data storage layer, information obtained from a security layer.

20. The method of claim 17, wherein the error information comprises indicators of the health of components of a mobility network.
